(19) United States
(12) Patent Application Publication
(10) Pub. No.: US 2026/0222330 A1
(43) Pub. Date: Jul. 30, 2026

(54) UNDERLAY MIGRATION AND INTEROPERABILITY MANAGEMENT

(71) Applicant: Cisco Technology, Inc., San Jose, CA (US)

(72) Inventors: Chuanfa Wang, Kanata (CA); Ali Sajassi, San Ramon, CA (US); Neeraj Malhotra, Los Gatos, CA (US)

(21) Appl. No.: 19/038,690

(22) Filed: Jan. 27, 2025

(51) Int. Cl. H04L 45/02; H04L 12/46; H04L 45/741

(52) U.S. Cl. CPC H04L 45/04; H04L 12/4633; H04L 45/741

(57) ABSTRACT

Devices, systems, methods, and processes for managing migration and interoperability between different protocol versions in an underlay network are provided herein. A network device may generate and transmit, while supporting a first Internet Protocol (IP) version type and a second IP version type, a plurality of route advertisements having the same originating router address during a BGP session. Each of the plurality of route advertisements includes a primary next-hop address that conforms to one of the first IP version type or the second IP version type, and a secondary next-hop address that conforms to remaining of the first IP version type or the second IP version type. Since the route advertisements transmitted during the BGP session have the same originating router address that is independent of an IP version type of the primary next-hop address, a route key associated with the network device remains the same.

The present disclosure relates to communication networks. More particularly, the present disclosure relates to managing migration and interoperability between different protocol versions in underlay networks.

### BACKGROUND

Currently, various Network Virtualization Overlay (NVO) solutions are available to provide seamless connectivity between Layer 2 (L2) and Layer 3 (L3) networks. Among the available NVO solutions, Ethernet Virtual Private Network (EVPN)-based Virtual Extensible Local Area Network (VXLAN) has been widely adopted in various sectors such as data centers, campus fabrics, service providers, and the public sector, for example. The widespread adoption of EVPN-based VXLAN may be driven by its ability to deliver scalable L2 and L3 connectivity while efficiently handling broadcast, unknown unicast, and multicast (BUM) traffic. VXLAN technology may utilize User Datagram Protocol (UDP) encapsulation, where an Internet Protocol (IP) header follows a UDP header. The IP header may include source and destination IP addresses corresponding to VXLAN Tunnel Endpoint (VTEP) addresses over which VXLAN tunnels are established. These VTEP addresses can be, for example, IP version 4 (IPv4) addresses or IPv6 addresses. By configuring EVPN routes for VTEPs with the IPv4 or IPv6 addresses, the EVPN-based VXLAN infrastructure can facilitate single-stack transport, such as IPv4-only or IPv6-only, for greenfield deployments.

Although newer transport protocols offers significant advantages over their predecessors, brownfield deployments that rely on legacy transport protocols may encounter challenges during migration and interoperability with newer transport protocols. To address these challenges, existing techniques may implement multi-transport, such as dual transport, mechanisms that support configurations for multiple protocol versions. Such multi-transport mechanism utilizes multiple next hop addresses on a VTEP, enabling a receiver end to select the appropriate transport protocol based on the network configuration.

However, despite the effectiveness of multi-transport in ensuring seamless migration and interoperability, the use of multi-transport mechanisms may introduce certain complexities in network operations. For example, during the migration process, a first VTEP operating on IPv4 transport may advertise an IPv4 originating router address to a second VTEP, resulting in the IPv4 originating router address being recorded in a flood list of the second VTEP. Subsequently, as the first VTEP transitions to IPv6 and before the migration is complete, the first VTEP may advertise both IPv6 and IPv4 originating router addresses. This behavior can result in the second VTEP recording duplicate addresses for the same VTEP in the flood list of the second VTEP. The presence of multiple originating router addresses for a single VTEP in the flood list can inadvertently lead to packet duplication, thereby creating inefficiencies in the network operations.

### SUMMARY OF THE DISCLOSURE

Systems and methods for managing migration and interoperability between different protocol versions, for example, an Internet Protocol (IP) version 4 (IPv4) transport and an IPv6 transport, in underlay networks in accordance with embodiments of the disclosure are described herein. In one aspect of the present disclosure, a multi-stack capable device is provided. The multi-stack capable device may comprise a processor and a memory communicatively coupled to the processor. The memory may comprise an interoperability management logic. The interoperability management logic may be configured to support a first IP version type and a second IP version type. Further, the interoperability management logic may be configured to generate a plurality of route advertisements having same originating router address during a border gateway protocol (BGP) session. Each route advertisement of the plurality of route advertisements may include a primary next-hop address and a secondary next-hop address of the multi-stack capable device. The primary next-hop address may conform to one of the first IP version type or the second IP version type independent of the originating router address. The secondary next-hop address may conform to remaining of the first IP version type or the second IP version type. Furthermore, the interoperability management logic may be configured to transmit the plurality of route advertisements.

In many embodiments, the originating router address may conform to one of the first IP version type or the second IP version type.

In many additional embodiments, the originating router address may be independent of an IP version type associated with the primary next-hop address.

In many further embodiments, based on the plurality of route advertisements having the same originating router address during the BGP session, a route key associated with the multi-stack capable device remains same during the BGP session.

In further embodiments, the primary next-hop address may be included in a first attribute of a corresponding route advertisement of the plurality of route advertisements, and the secondary next-hop address may be included in a second attribute of the corresponding route advertisement.

In still further embodiments, the first attribute may correspond to a Network Layer Reachability Information (NLRI) attribute.

In still yet further embodiments, the first attribute may correspond to a Multiprotocol Reachability NLRI (MP_REACH_NLRI) attribute.

In further additional embodiments, the second attribute may correspond to a BGP tunnel encapsulation attribute.

In additional embodiments, the second attribute may correspond to a Tunnel Egress Endpoint field within the BGP tunnel encapsulation attribute.

In still additional embodiments, the first IP version type may correspond to one of an IP version 4 (IPv4) or an IP version 6 (IPv6), and the second IP version type may correspond to remaining of the IPv4 or IPv6.

In still yet additional embodiments, the plurality of route advertisements may comprise at least one BGP route update advertisement.

In more embodiments, the interoperability management logic may be further configured to support a plurality of underlay network configurations including a first underlay network configuration associated with the first IP version type and a second underlay network configuration associated with the second IP version type.

In still more embodiments, the primary next-hop address may be associated with one of the first underlay network configuration or the second underlay network configuration that is prioritized for routing, and the secondary next-hop address may be associated with remaining of the first underlay network configuration or the second underlay network configuration.

In yet more embodiments, the primary next-hop address may conform to the first IP version type and the secondary next-hop address may conform to the second IP version type in a case where the first underlay network configuration is prioritized over the second underlay network configuration for routing.

In still yet more embodiments, the primary next-hop address may conform to the second IP version type and the secondary next-hop address may conform to the first IP version type in a case where the second underlay network configuration is prioritized over the first underlay network configuration for routing.

In another aspect of the present disclosure, a device is provided. The device may comprise a processor and a memory communicatively coupled to the processor. The memory may comprise an interoperability management logic. The interoperability management logic may be configured to switch from a first single-stack configuration supporting a first IP version type to a multi-stack configuration supporting the first IP version type and a second IP version type. Further, the interoperability management logic may be configured to generate, based on the switching to the multi-stack configuration, a first plurality of route advertisements having a same originating router address during a BGP session. Each route advertisement of the first plurality of route advertisements may include a primary next-hop address of the device. The primary next-hop address may conform to one of the first IP version type or the second IP version type independent of the originating router address. Furthermore, the interoperability management logic may be configured to transmit the first plurality of route advertisements.

In a number of embodiments, each route advertisement of the first plurality of route advertisements may further include a secondary next-hop address of the device. The secondary next-hop address may conform to remaining of the first IP version type or the second IP version type.

In various embodiments, the interoperability management logic may be further configured to switch from the multi-stack configuration supporting the first IP version type and the second IP version type to a second single-stack configuration supporting the second IP version type.

In several embodiments, prior to switching to the multi-stack configuration, the interoperability management logic may be further configured to transmit at least one route advertisement having the same originating router as the first plurality of route advertisements. In several more embodiments, based on the switching to the second single-stack configuration, the interoperability management logic may be further configured to transmit a second plurality of route advertisements having the same originating router address as the first plurality of route advertisements. In some more embodiments, each route advertisement of the second plurality of route advertisements may include a single next-hop address conforming to the second IP version type.

In yet another aspect of the present disclosure, a method is provided. The method may include supporting a first IP version type and a second IP version type. Further, the method may include generating a plurality of route advertisements having same originating router address during a BGP session. Each route advertisement of the plurality of route advertisements may include a primary next-hop address and a secondary next-hop address of a multi-stack capable device. The primary next-hop address may conform to one of the first IP version type or the second IP version type independent of the originating router address. The secondary next-hop address may conform to remaining of the first IP version type or the second IP version type. Furthermore, the method may include transmitting the plurality of route advertisements.

Other objects, advantages, novel features, and further scope of applicability of the present disclosure will be set forth in part in the detailed description to follow, and in part will become apparent to those skilled in the art upon examination of the following or may be learned by practice of the disclosure. Although the description above contains many specificities, these should not be construed as limiting the scope of the disclosure but as merely providing illustrations of some of the presently preferred embodiments of the disclosure. As such, various other embodiments are possible within its scope. Accordingly, the scope of the disclosure should be determined not by the embodiments illustrated, but by the appended claims and their equivalents.

### BRIEF DESCRIPTION OF DRAWINGS

The above, and other, aspects, features, and advantages of several embodiments of the present disclosure will be more apparent from the following description as presented in conjunction with the following several figures of the drawings.

FIG. 1 is a schematic block diagram of an example architecture for a network fabric in accordance with various embodiments of the disclosure;

FIG. 2 is diagram illustrating a conceptual migration procedure for migrating from a first transport protocol supporting a first Internet Protocol (IP) version type to a second transport protocol supporting a second IP version type in accordance with various embodiments of the disclosure;

FIG. 3 is a conceptual network fabric for interoperability between the IPv4 transport and the IPv6 transport in accordance with various embodiments of the disclosure;

FIG. 4 is an exemplary block diagram of a route advertisement in accordance with various embodiments of the disclosure;

FIG. 5 is a flowchart depicting a process for transmitting a plurality of route advertisements in accordance with various embodiments of the disclosure;

FIG. 6 is a flowchart depicting another process for transmitting the plurality of route advertisements in accordance with various embodiments of the disclosure;

FIG. 7 is a flowchart depicting a process for switching from a first single-stack configuration to a multi-stack configuration in accordance with various embodiments of the disclosure;

FIG. 8 is a flowchart depicting another process for switching from the first single-stack configuration to the multi-stack configuration in accordance with various embodiments of the disclosure;

FIG. 9 is a flowchart depicting a process for migrating from the first single-stack configuration to a second single-stack configuration in accordance with various embodiments of the disclosure;

FIG. 10 is a flowchart depicting a process for receiving one or more route advertisements in accordance with various embodiments of the disclosure; and

FIG. 11 is a conceptual block diagram of a device suitable for configuration with an interoperability management logic in accordance with various embodiments of the disclosure.

Corresponding reference characters indicate corresponding components throughout the several figures of the drawings. Elements in the several figures are illustrated for simplicity and clarity and have not necessarily been drawn to scale. For example, the dimensions of some of the elements in the figures might be emphasized relative to other elements for facilitating understanding of the various presently disclosed embodiments. In addition, common, but well-understood, elements that are useful or necessary in a commercially feasible embodiment are often not depicted in order to facilitate a less obstructed view of these various embodiments of the present disclosure.

### DETAILED DESCRIPTION

In response to the issues described above, devices and methods are discussed herein for managing migration and interoperability between different protocol versions, for example, an Internet Protocol (IP) version 4 (IPv4) transport and an IPv6 transport, in underlay networks. With the advent of newer transport protocols (for example, IPv6) many brownfield deployments relying on legacy transport protocols (for example, IPv4) want to migrate to the new transport protocols to leverage their advantages. During the migration, conventional techniques often implement multi-stack configurations (e.g., a dual-stack configuration supporting both IPv4 and IPv6 simultaneously). However, the usage of the multi-stack configurations may introduce certain complexities in network operations. For example, during the migration, a first device operating on IPv4 transport may advertise an IPv4 originating router address to a second device, which is then recorded in a flood list of the second device. Subsequently, as the first device transitions to IPv6, the first device may advertise both IPv6 and IPv4 originating router addresses. This behavior can result in the second device recording duplicate entries for the same device in the flood list of the second device. The presence of multiple originating router addresses for a single device in the flood list can inadvertently lead to packet duplication. To this end, in several embodiments, an interoperability management logic may be provided to avoid packet duplication.

In various embodiments, the interoperability management logic may be implemented within an underlay network fabric. In various examples, the underlay network fabric may include multiple Virtual Extensible Local Area Network (VXLAN) Tunnel Endpoints (VTEPs). For example, the underlay network fabric may include a first VTEP and a second VTEP. In numerous examples, at least one VTEP of the underlay network fabric may implement the interoperability management logic. For example, the first VTEP may implement the interoperability management logic.

In a variety of embodiments, the first VTEP may be configured to support a first single-stack configuration (also referred to as a first underlay network configuration) associated with a first IP version type. For example, the first IP version type may correspond to one of IPv4 or IPv6. In various examples, the first single-stack configuration may correspond to a first set of configurational parameters that enables the first VTEP to perform a first IP version type VXLAN encapsulation scheme (and/or a first IP version type VXLAN decapsulation scheme) by defining first IP version type addresses, VXLAN Network Identifiers (VNIs), and User Datagram Protocol (UDP) port numbers necessary for establishing VXLAN tunnels.

In many embodiments, upon supporting the first single-stack configuration, the first VTEP may establish a Border Gateway Protocol (BGP) session. In an example, the first VTEP may establish the BGP session with the second VTEP. In various examples, the BGP session may be established to advertise one or more Ethernet Virtual Private Network (EVPN) routes associated with the first VTEP. In some more examples, the BGP session may be established to migrate the first VTEP from a first IP version type transport to a second IP version type transport. Upon establishing the BGP session, the first VTEP may be configured to determine an originating router address associated with the first VTEP. In numerous examples, the originating router address may be determined based on an existing IPv4 address and/or an existing IPv6 address associated with the first VTEP. In various examples, the originating router address may conform to one of the first IP version type or a second IP version type. For example, the second IP version type may be different from the first IP version type. In an example, if the first IP version type corresponds to IPv4, the second IP version type may correspond to IPv6.

In many additional embodiments, upon determining the originating router address, the first VTEP may generate at least one route advertisement. In an example, the route advertisement may be a BGP route advertisement. For example, the route advertisement may include the determined originating router address and a first single next-hop address of the first VTEP. In an example, the first single next-hop address may conform to the first IP version type. Upon generating the route advertisement, the first VTEP may transmit (for example, broadcast or unicast) the route advertisement. For example, the first VTEP may transmit the route advertisement to the second VTEP. In an example, the transmission of the route advertisement may enable the second VTEP to update a flood list of the second VTEP to include information included in the route advertisement. Consequently, the second VTEP may be enabled to perform the first IP version type transport with the first VTEP.

In many further embodiments, the first VTEP may be configured to receive an update request for updating its set of configurational parameters. In various examples, the update request may be provided by a network operator, an administrator, or the like. In numerous examples, the update request may be a request to operate the first VTEP in a multi-stack configuration. Upon receiving the update request, the first VTEP may be configured to switch from the first single-stack configuration to the multi-stack configuration. In various examples, the multi-stack configuration may support both the first IP version type and the second IP version type. For example, in addition to being configured with the first set of configurational parameters, the first VTEP may be configured with a second set of configurational parameters based on the update request. The second set of configurational parameters may be associated with a second underlay network configuration that enables the first VTEP to additionally perform a second IP version type VXLAN encapsulation scheme (and/or a second IP version type VXLAN decapsulation scheme) by defining second IP version type addresses, VNIs, and UDP port numbers necessary for establishing VXLAN tunnels.

In further embodiments, upon switching to the multi-stack configuration, the first VTEP may be configured to identify the originating router address associated with the first VTEP. In various examples, to identify the originating router address, the first VTEP may determine whether the originating router address was previously determined for the first VTEP during the BGP session. In an example, if the originating router address was previously determined, the first VTEP may identify the same originating router address that was previously determined during the BGP session. Conversely, if the originating router address is absent, the first VTEP may identify the originating router address based on the existing IPv4 address and/or the existing IPv6 address associated with the first VTEP.

In still further embodiments, upon identifying the originating router address, the first VTEP may determine, among the first underlay network configuration and the second underlay network configuration, a prioritized underlay network configuration for routing. In an example, the prioritized underlay network configuration may be determined based on an underlay network configuration supported by the second VTEP. For example, if the second VTEP supports the first underlay network configuration, the first VTEP may determine the first underlay network configuration as the prioritized underlay network configuration. Conversely, if the second VTEP supports the second underlay network configuration, the first VTEP may determine the second underlay network configuration as the prioritized underlay network configuration. Upon determining the prioritized underlay network configuration, the first VTEP may determine a primary next-hop address and a second next-hop address associated with the first VTEP. In many examples, the primary next-hop address may conform to one of the first IP version type or the second IP version type supported by the prioritized underlay network configuration. For example, if the prioritized underlay network configuration supports the first IP version type, the first VTEP may determine the primary and secondary next-hop addresses such that the primary and secondary next-hop addresses conform to the first IP version type and the second IP version type, respectively. Conversely, if the prioritized underlay network configuration supports the second IP version type, the first VTEP may determine the primary and secondary next-hop addresses such that the primary and secondary next-hop addresses conform to the second IP version type and the first IP version type, respectively. In various examples, the primary and secondary next-hop addresses may correspond to IPv4 and IPv6 addresses of the first VTEP, respectively.

In still yet further embodiments, upon determining the primary and secondary next-hop addresses, the first VTEP may generate a first plurality of route advertisements having the same originating router address during the BGP session. In various examples, each route advertisement of the first plurality of route advertisements may include the identified originating router address and the determined primary and secondary next-hop addresses. In numerous examples, the first plurality of route advertisements may correspond to a first plurality of BGP route update advertisements. In numerous additional examples, the primary next-hop address and the secondary next-hop address may be included in a first attribute and a second attribute of each of the first plurality of BGP route update advertisements, respectively. In an example, the first attribute may correspond to a Network Layer Reachability Information (NLRI) attribute. More specifically, the first attribute may correspond to a Multiprotocol Reachability NLRI (MP_REACH_NLRI) attribute. The second attribute may correspond to a BGP tunnel encapsulation attribute. Specifically, the second attribute may correspond to a Tunnel Egress Endpoint field within the BGP tunnel encapsulation attribute.

In further additional embodiments, upon generating the first plurality of route advertisements, the first VTEP may transmit (for example, broadcast or unicast) the first plurality of route advertisements. For example, the first VTEP may transmit the first plurality of route advertisements to the second VTEP. In many examples, the transmission of the first plurality of route advertisements having the same originating router address during the BGP session allows a route key associated with the first VTEP to remain consistent (or same) during the BGP session. Accordingly, upon receiving the first plurality of route advertisements, the second VTEP may update the flood list associated with the second VTEP to modify an existing list of addresses for the first VTEP instead of recording information included in the first plurality of route advertisements as a new list of addresses. Consequently, the creation of duplicate addresses for the first VTEP in the flood list of the second VTEP may be avoided.

In additional embodiments, the first VTEP may be configured to receive one or more route advertisements from the second VTEP. In an example, the received route advertisements may include an originating router address associated with the second VTEP and at least one next-hop address associated with the second VTEP. Upon receiving the route advertisements, the first VTEP may be configured to determine whether the second VTEP supports at least one of the multi-stack configuration or a second single-stack configuration that supports the second IP version type.

In still additional embodiments, the first VTEP may be configured to switch from the multi-stack configuration to the second single-stack configuration. Upon switching to the second single-stack configuration, the first VTEP may be configured to identify the same originating router address that was previously determined during the BGP session. Further, the first VTEP may be configured to generate a second plurality of route advertisements having the same originating router address during the BGP session. In various examples, the second plurality of route advertisements may correspond to a second plurality of BGP route update advertisements. In numerous examples, each route advertisement of the second plurality of route advertisements may include the identified originating router address and a second single next-hop address. In an example, the second single next-hop address may conform to the second IP version type.

In still yet additional embodiments, upon generating the second plurality of route advertisements, the first VTEP may transmit (e.g., broadcast or unicast) the second plurality of route advertisements. In an example, the first VTEP may transmit the second plurality of route advertisements to the second VTEP. In many examples, the transmission of the second plurality of route advertisements having the same originating router address during the BGP session may allow the route key associated with the first VTEP to remain the same or consistent during the BGP session. Accordingly, upon receiving the second plurality of route advertisements, the second VTEP may not record duplicate entries for the first VTEP in the flood list associated with the second VTEP. Consequently, inefficiencies (e.g., packet duplication) in the network operations of the underlay network fabric may be suppressed.

Advantageously, the present disclosure allows the first VTEP to transmit a plurality of route advertisements (e.g., the first plurality of route advertisements and the second plurality of route advertisements) having the same originating router address during the BGP session, irrespective of an ongoing migration event for a new transport protocol. Such transmission of the plurality of route advertisements having the same originating router address enable a route key associated with the first VTEP to remain the same or consistent during the entire BGP session, irrespective of the ongoing migration event. Accordingly, the receiving device may update its flood list to modify an existing list of next hop addresses for the first VTEP rather than recording the multiple next hop addresses included in the plurality of route advertisements as a new list of addresses. Therefore, the creation of duplicate addresses for the first VTEP in the flood list of the receiving device may be avoided. Consequently, various migration or interoperability related inefficiencies in the network operations of the underlay network fabric may be suppressed.

Aspects of the present disclosure may be embodied as an apparatus, system, method, or computer program product. Accordingly, aspects of the present disclosure may take the form of an entirely hardware embodiment, an entirely software embodiment (including firmware, resident software, micro-code, or the like) or an embodiment combining software and hardware aspects that may all generally be referred to herein as a “function,” “module,” “apparatus,” or “system.” Furthermore, aspects of the present disclosure may take the form of a computer program product embodied in one or more non-transitory computer-readable storage media storing computer-readable and/or executable program code. Many of the functional units described in this specification have been labeled as functions, in order to emphasize their implementation independence more particularly. For example, a function may be implemented as a hardware circuit comprising custom VLSI circuits or gate arrays, off-the-shelf semiconductors such as logic chips, transistors, or other discrete components. A function may also be implemented in programmable hardware devices such as via field programmable gate arrays, programmable array logic, programmable logic devices, or the like.

Functions may also be implemented at least partially in software for execution by various types of processors. An identified function of executable code may, for instance, comprise one or more physical or logical blocks of computer instructions that may, for instance, be organized as an object, procedure, or function. Nevertheless, the executables of an identified function need not be physically located together but may comprise disparate instructions stored in different locations which, when joined logically together, comprise the function and achieve the stated purpose for the function.

Indeed, a function of executable code may include a single instruction, or many instructions, and may even be distributed over several different code segments, among different programs, across several storage devices, or the like. Where a function or portions of a function are implemented in software, the software portions may be stored on one or more computer-readable and/or executable storage media. Any combination of one or more computer-readable storage media may be utilized. A computer-readable storage medium may include, for example, but not limited to, an electronic, magnetic, optical, electromagnetic, infrared, or semiconductor system, apparatus, or device, or any suitable combination of the foregoing, but would not include propagating signals. In the context of this document, a computer readable and/or executable storage medium may be any tangible and/or non-transitory medium that may contain or store a program for use by or in connection with an instruction execution system, apparatus, processor, or device.

Computer program code for carrying out operations for aspects of the present disclosure may be written in any combination of one or more programming languages, including an object-oriented programming language such as Python, Java, Smalltalk, C++, C#, Objective C, or the like, conventional procedural programming languages, such as the “C” programming language, scripting programming languages, and/or other similar programming languages. The program code may execute partly or entirely on one or more of a user's computer and/or on a remote computer or server over a data network or the like.

A component, as used herein, comprises a tangible, physical, non-transitory device. For example, a component may be implemented as a hardware logic circuit comprising custom VLSI circuits, gate arrays, or other integrated circuits; off-the-shelf semiconductors such as logic chips, transistors, or other discrete devices; and/or other mechanical or electrical devices. A component may also be implemented in programmable hardware devices such as field programmable gate arrays, programmable array logic, programmable logic devices, or the like. A component may comprise one or more silicon integrated circuit devices (e.g., chips, die, die planes, packages) or other discrete electrical devices, in electrical communication with one or more other components through electrical lines of a printed circuit board (PCB) or the like. Each of the functions and/or modules described herein, in certain embodiments, may alternatively be embodied by or implemented as a component.

A circuit, as used herein, comprises a set of one or more electrical and/or electronic components providing one or more pathways for electrical current. In certain embodiments, a circuit may include a return pathway for electrical current, so that the circuit is a closed loop. In another embodiment, however, a set of components that does not include a return pathway for electrical current may be referred to as a circuit (e.g., an open loop). For example, an integrated circuit may be referred to as a circuit regardless of whether the integrated circuit is coupled to ground (as a return pathway for electrical current) or not. In various embodiments, a circuit may include a portion of an integrated circuit, an integrated circuit, a set of integrated circuits, a set of non-integrated electrical and/or electrical components with or without integrated circuit devices, or the like. In one embodiment, a circuit may include custom VLSI circuits, gate arrays, logic circuits, or other integrated circuits; off-the-shelf semiconductors such as logic chips, transistors, or other discrete devices; and/or other mechanical or electrical devices. A circuit may also be implemented as a synthesized circuit in a programmable hardware device such as field programmable gate array, programmable array logic, programmable logic device, or the like (e.g., as firmware, a netlist, or the like). A circuit may comprise one or more silicon integrated circuit devices (e.g., chips, die, die planes, packages) or other discrete electrical devices, in electrical communication with one or more other components through electrical lines of a printed circuit board (PCB) or the like. Each of the functions and/or modules described herein, in certain embodiments, may be embodied by or implemented as a circuit.

Reference throughout this specification to “one embodiment,” “an embodiment,” or similar language means that a particular feature, structure, or characteristic described in connection with the embodiment is included in at least one embodiment of the present disclosure. Thus, appearances of the phrases “in one embodiment,” “in an embodiment,” and similar language throughout this specification may, but do not necessarily, all refer to the same embodiment, but mean “one or more but not all embodiments” unless expressly specified otherwise. The terms “including,” “comprising,” “having,” and variations thereof mean “including but not limited to”, unless expressly specified otherwise. An enumerated listing of items does not imply that any or all of the items are mutually exclusive and/or mutually inclusive, unless expressly specified otherwise. The terms “a,” “an,” and “the” also refer to “one or more” unless expressly specified otherwise.

Further, as used herein, reference to reading, writing, storing, buffering, and/or transferring data can include the entirety of the data, a portion of the data, a set of the data, and/or a subset of the data. Likewise, reference to reading, writing, storing, buffering, and/or transferring non-host data can include the entirety of the non-host data, a portion of the non-host data, a set of the non-host data, and/or a subset of the non-host data.

Lastly, the terms “or” and “and/or” as used herein are to be interpreted as inclusive or meaning any one or any combination. Therefore, “A, B or C” or “A, B and/or C” mean “any of the following: A; B; C; A and B; A and C; B and C; A, B and C.” An exception to this definition will occur only when a combination of elements, functions, steps, or acts are in some way inherently mutually exclusive.

Aspects of the present disclosure are described below with reference to schematic flowchart diagrams and/or schematic block diagrams of methods, apparatuses, systems, and computer program products according to embodiments of the disclosure. It will be understood that each block of the schematic flowchart diagrams and/or schematic block diagrams, and combinations of blocks in the schematic flowchart diagrams and/or schematic block diagrams, can be implemented by computer program instructions. These computer program instructions may be provided to a processor of a computer or other programmable data processing apparatus to produce a machine, such that the instructions, which execute via the processor or other programmable data processing apparatus, create means for implementing the functions and/or acts specified in the schematic flowchart diagrams and/or schematic block diagrams block or blocks.

It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. Other steps and methods may be conceived that are equivalent in function, logic, or effect to one or more blocks, or portions thereof, of the illustrated figures. Although various arrow types and line types may be employed in the flowchart and/or block diagrams, they are understood not to limit the scope of the corresponding embodiments. For instance, an arrow may indicate a waiting or monitoring period of unspecified duration between enumerated steps of the depicted embodiment.

In the following detailed description, reference is made to the accompanying drawings, which form a part thereof. The foregoing summary is illustrative only and is not intended to be in any way limiting. In addition to the illustrative aspects, embodiments, and features described above, further aspects, embodiments, and features will become apparent by reference to the drawings and the following detailed description. The description of elements in each figure may refer to elements of proceeding figures. Like numbers may refer to like elements in the figures, including alternate embodiments of like elements.

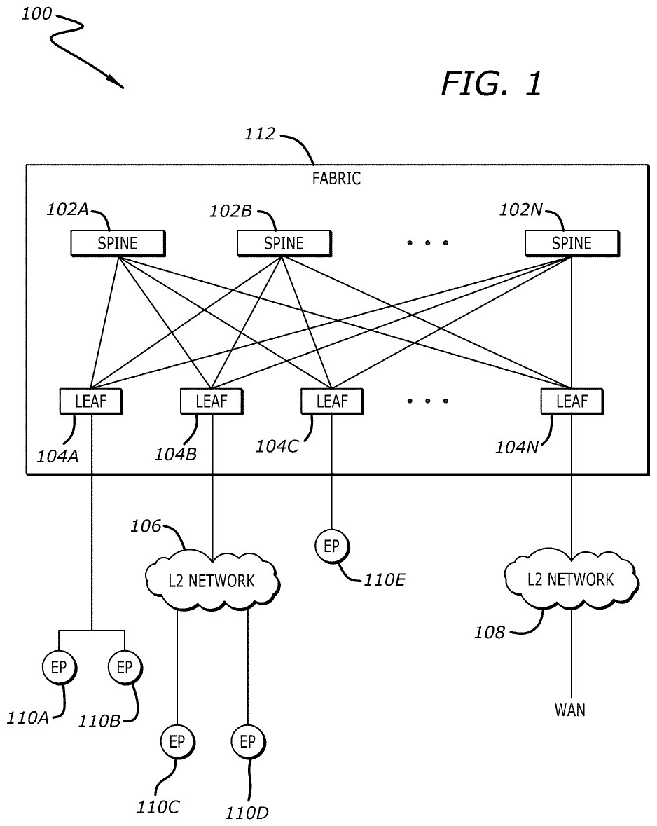

Referring to FIG. 1, a schematic block diagram of an example architecture 100 for a network fabric 112 in accordance with various embodiments of the disclosure is shown. The network fabric 112 may include spine switches 102A, 102B, . . . 102N (collectively “102”) connected to leaf switches 104A, 104B, 104C, . . . 104N (collectively “104”) in the network fabric 112. As those skilled in the art will recognize, the network fabric 112 can refer to a high-speed, high-bandwidth interconnect system that enables multiple devices to communicate with each other efficiently and reliably. It is a network topology that is designed to provide a flexible and scalable infrastructure for data center, cloud environments, and other network elements.

Various embodiments described herein can include a leaf-spine architecture comprising a plurality of spine switches and leaf switches. In an example, the leaf-spine architecture may include the spine switches 102 and the leaf switches 104. The spine switches 102 can be Layer 3 (L3) switches in the network fabric 112. However, in some cases, the spine switches 102 can also, or otherwise, perform Layer 2 (L2) functionalities. Further, the spine switches 102 can support various capabilities, such as, but not limited to, 40 or 10 Gbps Ethernet speeds. To this end, the spine switches 102 can be configured with one or more 40 Gigabit Ethernet ports. In certain embodiments, each port can also be split to support other speeds. For example, a 40 Gigabit Ethernet port can be split into four 10 Gigabit Ethernet ports, although a variety of other combinations are available.

In many embodiments, one or more of the spine switches 102 can be configured to host a proxy function that performs a lookup of the endpoint address identifier to locator mapping in a mapping database on behalf of leaf switches 104 that do not have such mapping. The proxy function can do this by parsing through the packet to the encapsulated tenant packet to get to the destination locator address of the tenant. The spine switches 102 can then perform a lookup of their local mapping database to determine the correct locator address of the packet and forward the packet to the locator address without changing certain fields in the header of the packet.

In various embodiments, when a packet is received at a spine switch 102i, where subscript “i” indicates that this operation may occur at any spine switch 102A to 102N, the spine switch 102i can first check if the destination locator address is a proxy address. If so, the spine switch 102i can perform the proxy function as previously mentioned. If not, the spine switch 102i can look up the locator in its forwarding table and forward the packet accordingly.

In a number of embodiments, one or more spine switches 102 can connect to one or more leaf switches 104 within the network fabric 112. The leaf switches 104 can include access ports (or non-fabric ports) and fabric ports. Fabric ports can provide uplinks to the spine switches 102, while access ports can provide connectivity for devices, hosts, endpoints, Virtual Machines (VMs), or external networks to the network fabric 112.

In more embodiments, leaf switches 104 can reside at the edge of the network fabric 112, and can thus represent the physical network edge. In some cases, the leaf switches 104 can be top-of-rack (“ToR”) switches configured according to a ToR architecture. In other cases, the leaf switches 104 can be aggregation switches in any particular topology, such as end-of-row (EoR) or middle-of-row (MoR) topologies. The leaf switches 104 can also represent aggregation switches, for example.

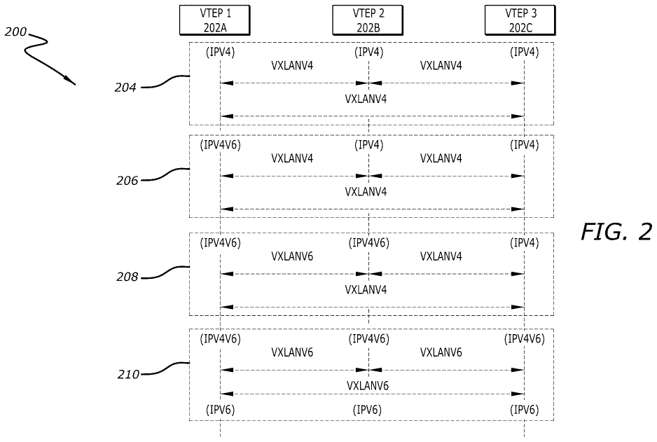

In additional embodiments, the leaf switches 104 can be responsible for routing and/or bridging various packets and applying network policies. In some cases, a leaf switch can perform one or more additional functions, such as implementing a mapping cache, sending packets to the proxy function when there is a miss in the cache, encapsulate packets, enforce ingress or egress policies, etc. Moreover, the leaf switches 104 can contain virtual switching functionalities, such as a Virtual Extensible Local Area Network (VXLAN) Tunnel Endpoint (VTEP) function as explained below in the discussion of FIG. 2. To this end, the leaf switches 104 can connect the network fabric 112 to an overlay network.

In further embodiments, network connectivity in the network fabric 112 can flow through the leaf switches 104. Here, the leaf switches 104 can provide servers, resources, endpoints, external networks, or VMs access to the network fabric 112, and can connect the leaf switches 104 to each other. In some cases, the leaf switches 104 can connect endpoint groups to the network fabric 112 and/or any external networks. Each endpoint group can connect to the network fabric 112 via one of the leaf switches 104, for example.

Endpoints 110 A-E (collectively “110”, shown as “EP”) can connect to the network fabric 112 via the leaf switches 104. For example, endpoints 110A and 110B can connect directly to a leaf switch 104A, which can connect the endpoints 110A and 110B to the network fabric 112 and/or any other one of the leaf switches 104. Similarly, an endpoint 110E can connect directly to a leaf switch 104C, which can connect the endpoint 110E to the network fabric 112 and/or any other of the leaf switches 104. On the other hand, endpoints 110C and 110D can connect to a leaf switch 104B via an L2 network 106. Similarly, the Wide Area Network (WAN) can connect to a leaf switch 104N via an L3 network 108.

In certain embodiments, the endpoints 110 can include any communication device, such as a computer, a server, a switch, a router, etc. In some cases, the endpoints 110 can include a server, hypervisor, or switch configured with a VTEP functionality which connects the overlay network with the network fabric 112. For example, in some cases, the endpoints 110 can represent one or more VTEPs. In an example, the VTEPs can connect to the network fabric 112 via the leaf switches 104. The overlay network can host physical devices, such as servers, applications, endpoint groups, virtual segments, virtual workloads, etc. In addition, the endpoints 110 can host virtual workload(s), clusters, and applications or services, which can connect with the network fabric 112 or any other device or network, including an external network. For example, one or more endpoints 110 can host, or connect to, a cluster of load balancers or an endpoint group of various applications.

Although a specific embodiment for an architecture 100 is described above with respect to FIG. 1, any of a variety of systems and/or processes may be utilized in accordance with embodiments of the disclosure. For example, the architecture 100 could comprise any variety of endpoints, spine switches, and/or leaf switches. The elements depicted in FIG. 1 may also be interchangeable with other elements of FIGS. 2-11 as required to realize a particularly desired embodiment.

Referring to FIG. 2, a diagram illustrating a conceptual migration procedure 200 for migrating from a first transport protocol supporting a first Internet Protocol (IP) version type to a second transport protocol supporting a second IP version type in accordance with various embodiments of the disclosure is shown. In a non-limiting example, the first transport protocol supporting the first IP version type is shown as IP version 4 (IPv4) transport and the second transport protocol supporting the second IP version type is shown as an IPv6 transport, in FIG. 2. However, the roles of the transport protocols are not fixed and could be reversed, with the first transport protocol supporting a later version and the second supporting an earlier version. Additionally, the transport protocols referenced in this example are not limited to IP-based protocols (e.g., IPv4 and IPv6) and can represent entirely different protocol types or versions, such as proprietary, application-specific, or other layer-specific protocols, depending on the architectural design, operational requirements, or network configurations, without deviating from the scope of the disclosure.

For the embodiments shown in FIG. 2, the migration procedure 200 is explained with a non-limiting example considering a three-node VXLAN fabric. For example, the three-node VXLAN fabric may include a first VTEP 202A (shown as “VTEP 1” in FIG. 2), a second VTEP 202B (shown as “VTEP 2” in FIG. 2), and a third VTEP 202C (shown as “VTEP 3” in FIG. 2). As used herein, a VTEP may refer to a network device (e.g., a computer, a server, a switch, a router, or the like) that encapsulates (and/or decapsulates) Layer 2 frames into VXLAN packets for transmission over an IP-based underlay network.

In a number of embodiments, each of the first through third VTEPs 202A-202C may include a processor and a memory communicatively coupled to the processor. The processor may include suitable logic, circuitry, and interfaces that are configured to execute instructions stored in the memory. For example, the processor may correspond to an application-specific integrated circuit (ASIC) processor, a complex instruction set computing (CISC) processor, a central processing unit (CPU), an explicitly parallel instruction computing (EPIC) processor, a very long instruction word (VLIW) processor, and/or other processors or circuits. The memory may comprise suitable logic, circuitry, and interfaces that are configured to store a machine code and/or the instructions executable by the processor. For example, the memory may correspond to random access memory (RAM), read only memory (ROM), electrically erasable programmable read-only memory (EEPROM), hard disk drive (HDD), a solid-state drive (SSD), a CPU cache, and/or a secure digital (SD) card.

In a variety of embodiments, the three-node VXLAN fabric may embody an interoperability management logic that enables the first through third VTEPs 202A-202C to seamlessly perform the migration procedure 200. In various examples, the interoperability management logic may be embodied within the memories of the first through third VTEPs 202A-202C. In more examples, the interoperability management logic may be embodied within the processors of the first through third VTEPs 202A-202C. In some more examples, the interoperability management logic may be provided as a standalone entity within each of the first through third VTEPs 202A-202C.

For the embodiments shown in FIG. 2, the migration procedure 200 may include steps 204-210 to migrate the three-node VXLAN fabric from the IPv4 transport to the IPv6 transport. In many embodiments, at step 204 of the migration procedure 200, each of the first through third VTEPs 202A-202C may be configured to perform the first IP version type transport (e.g., the IPv4 transport) with each other VTEP of the three-node VXLAN fabric. In many examples, in order to perform the first IP version type transport, each of the first through third VTEPs 202A-202C may be configured to support a first single-stack configuration (also referred to as a first underlay network configuration) associated with the first IP version type, for example, IPv4. As used herein, the first single-stack configuration may correspond to a first set of configurational parameters that enables a VTEP of the first through third VTEPs 202A-202C to perform a first IP version type VXLAN encapsulation scheme (and/or a first IP version type VXLAN decapsulation scheme) by defining first IP version type addresses, VXLAN Network Identifiers (VNIs), and User Datagram Protocol (UDP) port numbers necessary for establishing VXLAN tunnels. For the embodiments shown in FIG. 2, the first IP version type may correspond to the IPv4.

Further, each of the first through third VTEPs 202A-202C may be configured to establish a session with each other VTEP of the three-node VXLAN fabric. For example, the first VTEP 202A may establish the session with each of the second VTEP 202B and the third VTEP 202C. In various examples, the established session may correspond to a Border Gateway Protocol (BGP) session. Upon establishing the session, each of the first through third VTEPs 202A-202C may be configured to determine a corresponding originating router address (also referred to as a router identifier). For example, the first VTEP 202A may determine a first originating router address associated with the first VTEP 202A. In numerous examples, the first originating router address may be determined in such a way that the first originating router address conforms to the first IP version type supported by the first VTEP 202A. In various examples, the first originating router address may be determined based on an existing IPv4 address associated with the first VTEP 202A. In some more examples, the originating router address may be determined based on a manual IPv4 formatted address. In an example, the size of the first originating router address may be 4 octets. Likewise, the second VTEP 202B may determine a second originating router address and the third VTEP 202C may determine a third originating router address.

In many additional embodiments, upon determining the corresponding originating router addresses, each of the first through third VTEPs 202A-202C may be configured to generate at least one route advertisement. In an example, the at least one route advertisement may be generated for advertising one or more Ethernet Virtual Private Network (EVPN) routes (or VXLAN tunnels) associated with the corresponding VTEP. In various examples, the at least one route advertisement may include the determined originating router address and a first single next-hop address associated with the corresponding VTEP. In many examples, the first single next-hop address may correspond to an IPv4 address associated with the corresponding VTEP. Upon generating the at least one route advertisement, each of the first through third VTEPs 202A-202C may be configured to transmit the at least one route advertisement to other VTEPs in the three-node VXLAN fabric. In many examples, the transmission of the at least one route advertisement may enable each of the first through third VTEPs 202A-202C to update its flood list. In many additional examples, the updating of the flood list may enable each of the first through third VTEPs 202A-202C to uniquely identify other VTEPs of the three-node VXLAN fabric by utilizing the corresponding originating router addresses. In many further examples, the updating of the flood list may further enable each of the first through third VTEPs 202A-202C to exchange one or more VXLAN-encapsulated data packets with other VTEPs of the three-node VXLAN fabric by utilizing corresponding first single next-hop addresses.

In many further embodiments, at step 206 of the migration procedure 200, the three-node VXLAN fabric may be configured to receive a first update request for updating the first single-stack configuration to a multi-stack configuration. In various examples, the multi-stack configuration may support both the first IP version type and the second IP version type. For example, the multi-stack configuration may include the first set of configurational parameters as well as a second set of configurational parameters. The second set of configurational parameters may enable a VTEP to perform a second IP version type VXLAN encapsulation scheme (and/or a second IP version type VXLAN decapsulation scheme) by defining second IP version type addresses, the VNIs, and the UDP port numbers necessary for establishing VXLAN tunnels. In other words, the multi-stack configuration may enable a VTEP to perform both the first IP version type VXLAN encapsulation scheme (and/or the first IP version type VXLAN decapsulation scheme) and the second IP version type VXLAN encapsulation scheme (and/or the second IP version type VXLAN decapsulation scheme). In many examples, the first update request may be received by at least one VTEP of the three-node VXLAN fabric. For the embodiments shown in FIG. 2, at step 206 of the migration procedure 200, the first VTEP 202A may receive the first update request within the established session.

In further embodiments, upon receiving the first update request, the first VTEP 202A may be configured to switch from the first single-stack configuration to the multi-stack configuration. In an example, the switching of the first single-stack configuration to the multi-stack configuration may include further configuring the first VTEP 202A with the second set of configurational parameters. The second set of configurational parameters may be associated with a second underlay network configuration that supports the second IP version type. In still further embodiments, upon switching from the first single-stack configuration to the multi-stack configuration, the first VTEP 202A may be configured to identify an originating router address associated with the first VTEP 202A. In various examples, to identify the originating router address associated with the first VTEP 202A, the first VTEP 202A may determine whether any originating router address for the first VTEP 202A was previously determined during the established session. For example, if an originating router address was previously determined, the first VTEP 202A may identify the same originating router address. Conversely, if an originating router address is absent for the first VTEP 202A, the first VTEP 202A may identify a new originating router address based on the existing IPv4 address or an existing IPv6 address associated with the first VTEP 202A. Continuing the above example, since the first VTEP 202A is already associated with the first originating router address, the first VTEP 202A may identify the same first originating router address and continue using it for the remainder of the session.

In still yet further embodiments, upon identifying the first originating router address, the first VTEP 202A may be configured to determine a prioritized underlay network configuration among the first underlay network configuration and the second underlay network configuration. In various examples, the first VTEP 202A may determine the prioritized underlay network configuration based on configurations supported by each of the second VTEP 202B and the third VTEP 202C. In an example, if each of the second VTEP 202B and the third VTEP 202C supports the first underlay network configuration, the first VTEP 202A may determine the first underlay network configuration as the prioritized underlay network configuration. Conversely, if each of the second VTEP 202B and the third VTEP 202C supports the second underlay network configuration, the first VTEP 202A may determine the second underlay network configuration as the prioritized underlay network configuration.

In further additional embodiments, upon determining the prioritized underlay network configuration, the first VTEP 202A may be configured to determine a primary next-hop address and a secondary next-hop address associated with the first VTEP 202A. For example, if the prioritized underlay network configuration corresponds to the first underlay network configuration, the first VTEP 202A may determine, as the primary and secondary next-hop addresses, the first IP version type address (e.g., an IPv4 address) and the second IP version type address (e.g., an IPv6 address) associated with the first VTEP 202A, respectively. Consequently, the primary next-hop address may conform to the first IP version type and the secondary next-hop address may conform to the second IP version type. Conversely, if the prioritized underlay network configuration corresponds to the second underlay network configuration, the first VTEP 202A may determine, as the primary and secondary next-hop addresses, the second and first IP version type addresses associated with the first VTEP 202A, respectively. Consequently, the primary next-hop address may conform to the second IP version type and the secondary next-hop address may conform to the first IP version type.

In additional embodiments, upon determining the primary next-hop address and the secondary next-hop address, the first VTEP 202A may be configured to generate a first plurality of route advertisements. In an example, each route advertisement of the first plurality of route advertisements may include the identified first originating router address, the primary next-hop address, and the secondary next-hop address. In various examples, each route advertisement of the first plurality of route advertisements may correspond to a BGP route update advertisement. For example, the primary next-hop address and the secondary next-hop address may be included within a first attribute of the BGP route update advertisement and a second attribute of the BGP route update advertisement, respectively. In many examples, the first attribute may correspond to at least one of a Network Layer Reachability Information (NLRI) attribute. More specifically, the first attribute may correspond to a Multiprotocol Reachable NLRI (MP_REACH_NLRI) attribute included in the BGP route update advertisement. In many additional examples, the second attribute may correspond to a BGP tunnel encapsulation attribute included in the BGP route update advertisement. More specifically, the second attribute may correspond to a Tunnel Egress Endpoint field within the BGP tunnel encapsulation attribute.

In still additional embodiments, upon generating the first plurality of route advertisements, the first VTEP 202A may be configured to transmit (e.g., broadcast or unicast) the first plurality of route advertisements. For example, the first VTEP 202A may transmit the first plurality of route advertisements to the second VTEP 202B and/or the third VTEP 202C. In many examples, upon receiving the first plurality of route advertisements, the second VTEP 202B (and/or the third VTEP 202C) may be configured to update the flood list associated with the second VTEP 202B (and/or the third VTEP 202C). In many additional examples, since the first plurality of route advertisements has the same first originating router address that was included in the at least one route advertisement prior to the switching, the second VTEP 202B (and/or the third VTEP 202C) may update the flood list to modify an existing list of addresses (e.g., the first originating router address and the first IP version type address) of the first VTEP 202A instead of recording information included in the first plurality of route advertisements as a new list of addresses. In an example, the flood list associated with the second VTEP 202B (and/or the third VTEP 202C) may be updated to include the second IP version type address associated with the first VTEP 202A. Consequently, the creation of duplicate addresses in the flood list of the second VTEP 202B (and/or the third VTEP 202C) may be avoided.

In various examples, the first originating router address included in the flood list may be utilized by the second VTEP 202B (and/or the third VTEP 202C) to uniquely identify the first VTEP 202A within the three-node VXLAN fabric. In some more examples, at least one of the first IP version type address or the second IP version type address may be utilized by the second VTEP 202B (and/or the third VTEP 202C) to forward the VXLAN-encapsulated data packets to the first VTEP 202A. For the embodiments shown in FIG. 2, since the second VTEP 202B and the third VTEP 202C are single-stack devices that only support the first single-stack configuration (e.g., the first underlay network configuration) at step 206 of the migration procedure 200, the second VTEP 202B (and/or the third VTEP 202C) may utilize the first IP version type address to forward the VXLAN-encapsulated data packets to the first VTEP 202A. Consequently, the three-node VXLAN fabric may continue to perform the IPv4 transport at step 206 of the migration procedure 200.

In still yet additional embodiments, at step 208 of the migration procedure 200, another VTEP of the three-node VXLAN fabric may be configured to switch from the first single-stack configuration to the multi-stack configuration. For the embodiments shown in FIG. 2, the second VTEP 202B may be configured to switch from the first single-stack configuration to the multi-stack configuration. In various examples, the second VTEP 202B may switch from the first single-stack configuration to the multi-stack configuration after the reception of the first plurality of route advertisements. In some more examples, the second VTEP 202B may switch from the first single-stack configuration to the multi-stack configuration based on receiving a second update request for updating its set of configuration parameters.

In more embodiments, upon switching from the first single-stack configuration to the multi-stack configuration, the second VTEP 202B may be configured to generate a second plurality of route advertisements. In an example, the second VTEP 202B may generate the second plurality of route advertisements in a manner similar to the first plurality of route advertisements generated by the first VTEP 202A. In various examples, each route advertisement of the second plurality of route advertisements may include the second originating router address already associated with the second VTEP 202B, a first IP version type address associated with the second VTEP 202B, and a second IP version type address associated with the second VTEP 202B. Further, the second VTEP 202B may transmit the second plurality of route advertisements to the first VTEP 202A and/or the third VTEP 202C.

Upon receiving the second plurality of route advertisements, the first VTEP 202A (and/or the third VTEP 202C) may be configured to update the flood list associated with the first VTEP 202A (and/or the third VTEP 202C). In an example, the flood list may be updated to include the second IP version type address associated with the second VTEP 202B. In many examples, the second originating router address associated with the second VTEP 202B may be utilized by the first VTEP 202A (and/or the third VTEP 202C) to uniquely identify the second VTEP 202B within the three-node VXLAN fabric. In many additional examples, since both the first VTEP 202A and the second VTEP 202B support the multi-stack configuration, the second IP version type address (e.g., the IPv6 address) associated with the second VTEP 202B may be utilized by the first VTEP 202A to forward the VXLAN-encapsulated data packets to the second VTEP 202B. Consequently, at step 208 of the migration procedure 200, the first and second VTEPs 202A and 202B in the three-node VXLAN fabric may perform the IPv6 transport while the first and third VTEPs 202A and 202C and the second and third VTEPs 202B and 202C may continue to perform the IPv4 transport.

In still more embodiments, at step 210 of the migration procedure 200, yet another VTEP of the three-node VXLAN fabric may be configured to switch from the first single-stack configuration to the multi-stack configuration. For the embodiments shown in FIG. 2, the third VTEP 202C may be configured to switch from the first single-stack configuration to the multi-stack configuration. In various examples, the third VTEP 202C may switch from the first single-stack configuration to the multi-stack configuration after the reception of the first plurality of route advertisements and/or the second plurality of route advertisements. In some more examples, the third VTEP 202C may switch from the first single-stack configuration to the multi-stack configuration based on receiving a third update request for updating its set of configuration parameters.

In yet more embodiments, upon switching from the first single-stack configuration to the multi-stack configuration, the third VTEP 202C may be configured to generate a third plurality of route advertisements. In an example, the third VTEP 202C may generate the third plurality of route advertisements in a manner similar to the first plurality of route advertisements generated by the first VTEP 202A. In various examples, each route advertisement of the third route advertisements may include the third originating router address associated with the third VTEP 202C, a first IP version type address associated with the third VTEP 202C, and a second IP version type address associated with the third VTEP 202C. Further, the third VTEP 202C may transmit the third plurality of route advertisements to the first VTEP 202A and/or the second VTEP 202B.

Upon receiving the third plurality of route advertisements, the first VTEP 202A (and/or the second VTEP 202B) may be configured to update the flood list associated with the first VTEP 202A (and/or the second VTEP 202B). In an example, the flood list may be updated to include the second IP version type address associated with the third VTEP 202C. In many examples, the third originating router address associated with the third VTEP 202C may be utilized by the first VTEP 202A (and/or the second VTEP 202B) to uniquely identify the third VTEP 202C within the three-node VXLAN fabric. In many additional examples, since all VTEPs of the three-node VXLAN fabric now support the multi-stack configuration, the second IP version type address (e.g., the IPv6 address) associated with the third VTEP 202C may be utilized by the first VTEP 202A (and/or the second VTEP 202B) to forward the VXLAN-encapsulated data packets to the third VTEP 202C. Consequently, at step 210 of the migration procedure 200, the three-node VXLAN fabric 202A-202C may perform the IPv6 transport.

In still yet more embodiments, at step 210 of the migration procedure 200, the first VTEP 202A may be configured to determine whether all VTEPs of the three-node VXLAN fabric support the second underlay network configuration. For example, the first VTEP 202A may determine, based on the flood list associated with the first VTEP 202A, whether all VTEPs of the three-node VXLAN fabric 202A-202C support the second underlay network configuration. In an example, if all VTEPs of the three-node VXLAN fabric support the second underlay network configuration, the first VTEP 202A may be configured to switch from the multi-stack configuration to a second single-stack configuration that only supports IPv6 transport. Conversely, if the three-node VXLAN fabric includes a VTEP that does not support the second underlay network configuration, the first VTEP 202A may wait until all VTEPs support the second underlay network configuration.

In several embodiments, upon switching from the multi-stack configuration to the second single-stack configuration, the first VTEP 202A may be configured to generate a fourth plurality of route advertisements. In various examples, in order to generate the fourth plurality of route advertisements, the first VTEP 202A may identify the first originating router address that was previously determined (and/or identified) during the established session. Further, the first VTEP 202A may determine a second single next-hop address. In an example, the second IP version type address associated with the first VTEP 202A may be determined as the second single next-hop address. Furthermore, the first VTEP 202A may generate the fourth plurality of route advertisements based on the identified first originating router address and the determined second IP version type address. In various examples, each route advertisement of the fourth plurality of route advertisements may include the identified first originating router address and the determined second IP version type address.

In several more embodiments, upon generating the fourth plurality of route advertisements, the first VTEP 202A may be configured to transmit (broadcast or unicast) the fourth plurality of route advertisements. In an example, the first VTEP 202A may transmit the fourth plurality of route advertisements to the second VTEP 202B and/or the third VTEP 202C. Upon receiving the fourth plurality of route advertisements, the second VTEP 202B (and/or the third VTEP 202C) may be configured to update the flood list associated with the second VTEP 202B (and/or the third VTEP 202C). In various examples, since the fourth plurality of route advertisements has the same first originating router address that was included in the at least route advertisement and/or the first plurality of route advertisements, the second VTEP 202B (and/or the third VTEP 202C) may update the flood list to modify the existing list of addresses (e.g., the first originating router address and the first and second IP version type addresses) of the first VTEP 202A instead of recording information included in the fourth plurality of route advertisements as a new list of addresses. In an example, the flood list associated with the second VTEP 202B (and/or the third VTEP 202C) may be updated to remove the first IP version type address associated with the first VTEP 202A. Consequently, the creation of duplicate addresses in the flood list of the second VTEP 202B (and/or the third VTEP 202C) may be avoided.

Similar to the first VTEP 202A, at step 210 of the migration procedure 200, the second VTEP 202B and the third VTEP 202C may also switch from the multi-stack configuration to the second single-stack configuration. Upon switching to the second single-stack configuration, the second VTEP 202B and the third VTEP 202C may generate a fifth plurality of route advertisements and a sixth plurality of route advertisements, respectively, similar to the fourth plurality of route advertisements generated by the first VTEP 202A. Further, the second VTEP 202B and the third VTEP 202C may transmit (e.g., broadcast or unicast) the generated fifth plurality of route advertisements and the generated sixth plurality of route advertisements, respectively.

In this way, the first VTEP 202A may be configured to generate and transmit a plurality of route advertisements (e.g., the at least one route advertisement, the first plurality of route advertisements, and the fourth plurality of route advertisements) having the same first originating router address during the entire session. Further, the transmission of the plurality of route advertisements having the same first originating router address allows a route key associated with the first VTEP 202A to remain the same during the established session. Accordingly, the second VTEP 202B (and/or the third VTEP 202C) may not create duplicate next-hop tunnels for the first VTEP 202A in their flood lists. Thus, the three-node VXLAN fabric may successfully migrate from the IPv4 transport to the IPv6 transport without experiencing migration or interoperability issues. As a result, inefficiencies (e.g., packet duplication) in network operations of the three-node VXLAN fabric may be suppressed.

Although a specific embodiment of the migration procedure 200 for migrating from a first transport protocol supporting a first Internet Protocol (IP) version type to a second transport protocol supporting a second IP version type is described above with respect to FIG. 2, any of a variety of systems and/or processes may be utilized in accordance with embodiments of the disclosure. For example, a migration procedure from the IPv6 transport to the IPv4 transport may also follow the same steps (e.g., steps 204-210), provided the originating router address for a VTEP in the three-node VXLAN fabric 202A-202C remains unchanged during the migration. The elements depicted in FIG. 2 may also be interchangeable with other elements of FIG. 1 and FIGS. 3-11 as required to realize a particularly desired embodiment.

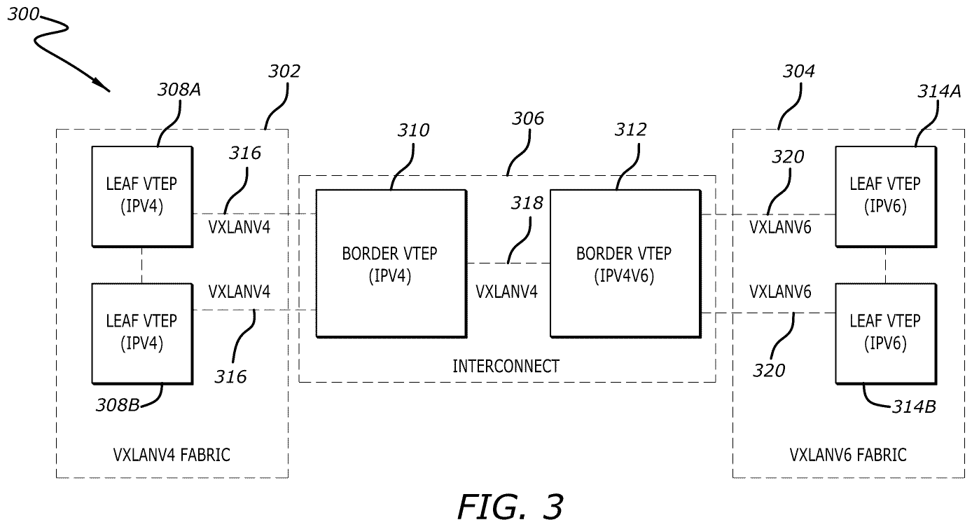

Referring to FIG. 3, a conceptual network fabric 300 for interoperability between the IPv4 transport and the IPv6 transport in accordance with various embodiments of the disclosure is shown. In the embodiments shown in FIG. 3, the network fabric 300 may include a VXLANv4 fabric 302, a VXLANv6 fabric 304, and an interconnect 306 that connects the VXLANv4 fabric 302 and the VXLANv6 fabric 304. For example, the VXLANv4 fabric 302 may include a plurality of leaf VTEPs 308A and 308B. In many embodiments, each leaf VTEP of the plurality of leaf VTEPs 308A and 308B may be configured to support an IPv4 protocol. For example, the interconnect 306 may include a plurality of border VTEPs 310 and 312. In many additional embodiments, at least one border VTEP of the interconnect 306 may be configured to support both the IPv4 protocol and an IPv6 protocol. For the embodiment shown in FIG. 3, a first border VTEP 310 of the interconnect 306 may support the IPv4 protocol, and a second border VTEP 312 of the interconnect 306 may support both the IPv4 protocol and the IPv6 protocol. For example, the VXLANv6 fabric 304 may include a plurality of leaf VTEPs 314A and 314B. In many further embodiments, each leaf VTEP of the plurality of leaf VTEPs 314A and 314B may be configured to support the IPv6 protocol.

In further embodiments, the VXLANv4 fabric 302 may be configured to perform the IPv4 transport with the interconnect 306. For example, each leaf VTEP of the plurality of leaf VTEPs 308A and 308B may be configured to perform the IPv4 transport with the first border VTEP 310 of the interconnect 306. In various examples, the plurality of leaf VTEPs 308A and 308B may perform the IPv4 transport with the first border VTEP 310 via VXLANv4 connections 316. In still further embodiments, in order to seamlessly perform the IPv4 transport, the plurality of leaf VTEPs 308A and 308B may be configured to transmit a first plurality of route advertisements. For example, the plurality of leaf VTEPs 308A and 308B may transmit the first plurality of route advertisements to the first border VTEP 310. In various examples, each route advertisement of the first plurality of route advertisements may include an originating router address associated with a respective leaf VTEP of the plurality of leaf VTEPs 308A and 308B and a single next-hop address associated with the respective leaf VTEP. In numerous examples, an IP version type of the single next-hop address associated with the respective leaf VTEP may be independent of an IP version type of the originating router address associated with the respective leaf VTEP, or vice versa. Upon receiving the first plurality of route advertisements, the first border VTEP 310 may be configured to update a first flood list associated with the first border VTEP 310. In an example, the first flood list may be updated to include information included in the first plurality of route advertisements.

In more embodiments, the interconnect 306 may be configured to perform the IPv4 transport with the VXLANv4 fabric 302 and/or the IPv6 transport with the VXLANv6 fabric 304. In various examples, the second border VTEP 312 of the interconnect 306 may be configured to perform the IPv4 transport with the VXLANv4 fabric 302 via the border VTEP 310 and a VXLANv4 connection 318. Further, the second border VTEP 312 may be configured to perform the IPv6 transport with the VXLANv6 fabric 304 via VXLANv6 connections 320. In still more embodiments, in order to seamlessly perform the IPv4 transport and/or the IPv6 transport, the second border VTEP 312 may be configured to transmit a second plurality of route advertisements. For example, the second border VTEP 312 may transmit the second plurality of route advertisements to the first border VTEP 310 and/or the plurality of leaf VTEPs 314A and 314B. In various examples, each route advertisement of the second plurality of route advertisements may include an originating router address associated with the second border VTEP 312, a primary next-hop address associated with the second border VTEP 312, and a secondary next-hop address associated with the second border VTEP 312. In numerous examples, an IP version type of the primary and/or secondary next-hop addresses may be independent of an IP version type of the originating router address associated with the second border VTEP 312, or vice versa.

In yet more embodiments, upon receiving the second plurality of route advertisements, the first border VTEP 310 may be configured to update the first flood list associated with the first border VTEP 310. In an example, the first flood list may be updated to include information included in the second plurality of route advertisements. In still yet more embodiments, upon receiving the second plurality of route advertisements, the first border VTEP 310 may transmit a third plurality of route advertisements to the second border VTEP 312. In an example, each route advertisement of the third plurality of route advertisements may include an originating router address associated with the first border VTEP 310 and a single next-hop address associated with the first border VTEP 310. In numerous examples, an IP version type of the single next-hop address associated with the first border VTEP 310 may be independent of an IP version type of the originating router address associated with the first border VTEP 310, or vice versa. Upon receiving the third plurality of route advertisements, the second border VTEP 312 may be configured to update a second flood list associated with the second border VTEP 312. In an example, the second flood list may be updated to include information included in the third plurality of route advertisements.

In additional embodiments, upon receiving the second plurality of route advertisements, each leaf VTEP of the plurality of leaf VTEPs 314A and 314B may be configured to update its third flood list. In an example, the third flood list may be updated to include information included in the second plurality of route advertisements. In many additional embodiments, upon receiving the second plurality of route advertisements, the plurality of leaf VTEPs 314A and 314B may be configured to transmit a fourth plurality of route advertisements to the second border VTEP 312. In an example, each route advertisement of the fourth plurality of route advertisements may include an originating router address associated with a respective leaf VTEP of the plurality of leaf VTEPs 314A and 314B and a single next-hop address associated with the respective leaf VTEP. In numerous examples, an IP version type of the single next-hop address associated with the respective leaf VTEP may be independent of an IP version type of the originating router address associated with the respective leaf VTEP, or vice versa. Upon receiving the fourth plurality of route advertisements, the second border VTEP 312 may be configured to update the second flood list associated with the second border VTEP 312. In an example, the second flood list may be updated to include information included in the fourth plurality of route advertisements.

Although a specific embodiment of the network fabric 300 for carrying out the various steps, processes, methods, and operations described herein is discussed with respect to FIG. 3, any of a variety of systems and/or processes may be utilized in accordance with embodiments of the disclosure. For example, the first border VTEP 310 may also support both the IPv4 protocol and an IPv6 protocol. The elements depicted in FIG. 3 may also be interchangeable with other elements of FIGS. 1-2 and FIGS. 4-11 as required to realize a particularly desired embodiment.

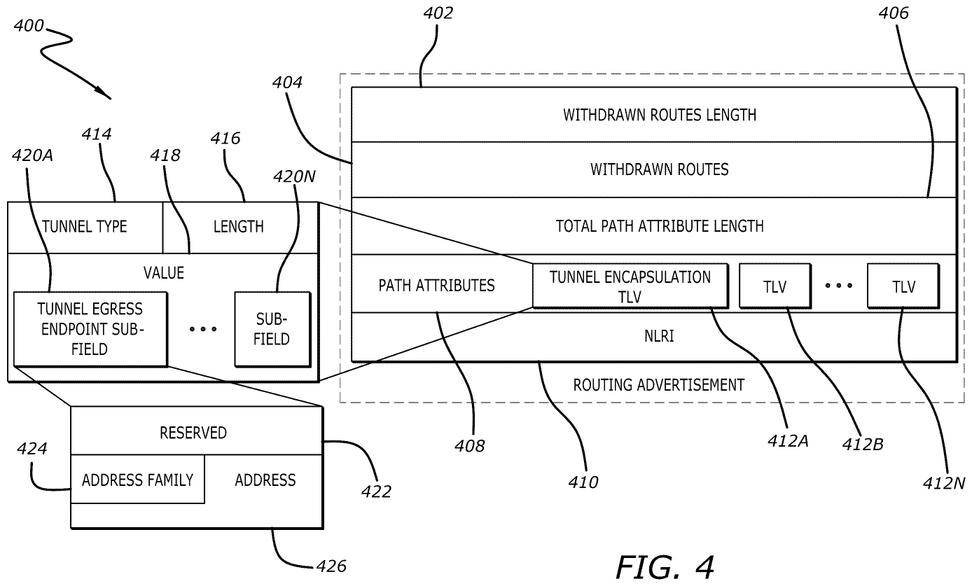

Referring to FIG. 4, an exemplary block diagram of a route advertisement 400 in accordance with various embodiments of the disclosure is shown. In various embodiments, the route advertisement 400 may correspond to a BGP route update advertisement that is transmitted by a VTEP. In a variety of embodiments, the route advertisement 400 may be configured to advertise EVPN routes (or VXLAN tunnels) associated with the VTEP. In a number of embodiments, the route advertisement 400 may include one or more of: a withdrawn routes length field 402, a withdrawn routes field 404, a total path attribute length field 406, a path attributes field 408, or an NLRI field 410. The withdrawn routes length field 402 may be configured to indicate the total length of the withdrawn routes field 404. The withdrawn routes field 404 may be configured to indicate a list of network layer address (e.g., IP address) prefixes for the EVPN routes being withdrawn from service. The total path attribute length field 406 may be configured to indicate the total length of the path attributes field 408. The path attributes field 408 may be configured to indicate one or more path attributes. For example, the path attributes may include a Multi_Exit_Disc (MED) attribute. The MED attribute may indicate a metric (e.g., cost) for reaching the advertised prefix. Further, the path attributes field 408 may indicate an originating router address.

In many embodiments, the NLRI field 410 may be configured to indicate a list of address prefixes associated with the VTEP. In an example, the NLRI field 410 may be configured to indicate a primary next-hop address associated with the VTEP. More specifically, the primary next-hop address may be included in an MP_REACH_NLRI field within the NLRI field 410. In various examples, the primary next-hop address may conform to one of an IPv4 address type or an IPv6 address type.

In additional embodiments, the path attributes field 408 may further include one or more tunnel encapsulation Type-Length-Value (TLV) fields 412A-412N. In numerous examples, each tunnel encapsulation TLV field of the tunnel encapsulation TLV fields 412A-412N may correspond to an optional transitive BGP route attribute described in RFC9012. In numerous additional examples, each tunnel encapsulation TLV field of the tunnel encapsulation TLV fields 412A-412N may be configured to indicate a specific tunnel associated with the VTEP. For example, each tunnel encapsulation TLV field of the tunnel encapsulation TLV fields 412A-412N may be configured to indicate a secondary next-hop address associated with the VTEP. In various examples, the secondary next-hop address may conform to remaining one of the IPv4 address type or the IPv6 address type. For example, if the primary next-hop address conforms to the IPv4 address type, the secondary next-hop address may conform to the IPv6 address type. Conversely, if the primary next-hop address conforms to the IPv6 address type, the secondary next-hop address may conform to the IPv4 address type.

In still additional embodiments, each tunnel encapsulation TLV field of the tunnel encapsulation TLV fields 412A-412N may include a tunnel type field 414, a length field 416, and/or a value field 418. The tunnel type field 414 may be configured to indicate a type of encapsulation scheme (e.g., the VXLAN encapsulation scheme) utilized for the tunnel. The length field 416 may be configured to indicate the total length of at least one of the tunnel type field 414 or the value field 418. The value field 418 may include one or more tunnel egress endpoint sub-fields 420A-420N. In various examples, each tunnel egress endpoint sub-field of the tunnel egress endpoint sub-fields 420A-420N may include a reserved sub-field 422, an address family sub-field 424, and an address sub-field 426. In an example, the address sub-field 426 may be configured to indicate the secondary next-hop address. The address family sub-field 424 may be configured to indicate an address type of the secondary next-hop address.

Although a specific embodiment of the route advertisement 400 for carrying out the various steps, processes, methods, and operations described herein is discussed with respect to FIG. 4, any of a variety of systems and/or processes may be utilized in accordance with embodiments of the disclosure. For example, the route advertisement 400 may include a single tunnel encapsulation TLV having a single tunnel egress endpoint sub-field. The elements depicted in FIG. 4 may also be interchangeable with other elements of FIGS. 1-3 and 5-1 as required to realize a particularly desired embodiment.

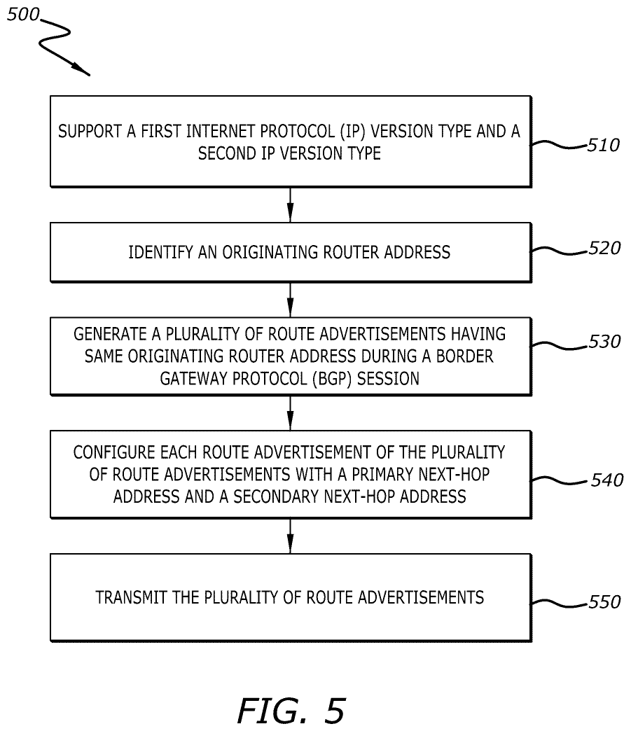

Referring to FIG. 5, a flowchart depicting a process 500 for transmitting a plurality of route advertisements in accordance with various embodiments of the disclosure is shown. In numerous embodiments, the process 500 may be implemented within a network fabric. In various examples, the network fabric may include multiple VTEPs. For example, each VTEP of the network fabric may correspond to a network device (e.g., a switch, a router, or the like) that encapsulates (and/or decapsulates) Layer 2 frames into VXLAN packets for transmission over an IP-based underlay network. In an example, the network fabric may include a first VTEP, a second VTEP, and a third VTEP. In numerous additional embodiments, at least one VTEP of the network fabric may establish a BGP session to migrate the network fabric from a first IP version type transport to a second IP type transport. For example, the first VTEP may establish the BGP session. In an example, the process 500 may be implemented by the first VTEP within the established BGP session.

In many embodiments, the process 500 may support a first IP version type and a second IP version type (block 510). In many examples, the first IP version type may correspond to one of an IPv4 protocol or an IPv6 protocol. The second IP version type may correspond to the remaining one of the IPv4 protocol or the IPv6 protocol. In numerous examples, in order to support both the first IP version type and the second IP version type, the process 500 may be configured to operate in a multi-stack configuration. In other words, the first VTEP may be a multi-stack capable device. In various examples, the multi-stack configuration may include a first underlay network configuration associated with the first IP version type and a second underlay network configuration associated with the second IP version type. As used herein, the first underlay network configuration may correspond to a first set of configurational parameters that enables the process 500 to perform a first IP version type VXLAN encapsulation scheme (and/or a first IP version type VXLAN decapsulation scheme) by defining the first IP version type addresses, VNIs, and UDP port numbers necessary for establishing VXLAN tunnels. As used herein, the second underlay network configuration may correspond to a second set of configurational parameters that enables the process 500 to perform a second IP version type VXLAN encapsulation scheme (and/or a second IP version type VXLAN decapsulation scheme) by defining the second IP version type addresses, VNIs, and UDP port numbers necessary for establishing VXLAN tunnels.

In more embodiments, the process 500 may identify an originating router address (block 520). In an example, the originating router address may correspond to a router identifier associated with the first VTEP. In various embodiments, the originating router address may be identified in such a way that the originating router address remains the same throughout the established BGP session. In still more embodiments, in order to ensure the originating router address remains the same, the process 500 may determine whether the originating router address was previously determined for the first VTEP during the established session. In an example, if the originating router address was previously determined, the process 500 may identify, as the originating router address, the same originating router address that was previously determined during the established session. Conversely, if the originating router address is absent for the first VTEP, the process 500 may identify the originating router address based on an existing IPv4 address and/or an existing IPv6 address associated with the first VTEP. In numerous examples, the originating router address may conform to one of the first IP version type or the second IP version type.

In yet more embodiments, the process 500 may generate the plurality of route advertisements having the same originating router address during the BGP session (block 530). In various examples, each route advertisement of the plurality of route advertisements may correspond to one of a BGP route advertisement or a BGP route update advertisement. In many examples, in order to generate the plurality of route advertisements, the process 500 may determine a primary next-hop address and a secondary next-hop address associated with the first VTEP. In many additional examples, the primary next-hop address may conform to one of the first IP version type or the second IP version type. For example, the primary next-hop address may correspond to one of an IPv4 address of the first VTEP or an IPv6 address of the first VTEP. In many further examples, the secondary next-hop address may conform to the remaining one of the first IP version type or the second IP version type. For example, the secondary next-hop address may correspond to the remaining one of the IPv4 or IPv6 addresses of the first VTEP. In numerous examples, the primary and secondary next-hop addresses may be determined in such a way that an IP version type of the primary and/or secondary next-hop addresses is independent of an IP version type of the originating router address. Further, the process 500 may generate the plurality of route advertisements based on the determined primary and secondary next-hop addresses. In an example, each route advertisement of the plurality of route advertisements may include the identified originating router address and the primary and secondary next-hop addresses.

In additional embodiments, the process 500 may configure each route advertisement of the plurality of route advertisements with the primary next-hop address and the secondary next-hop address (block 540). In numerous examples, the plurality of route advertisements may be configured in such a way that a first attribute of each route advertisement of the plurality of route advertisements includes the primary next-hop address and a second attribute of each route advertisement of the plurality of route advertisements includes the secondary next-hop address. In many examples, the first attribute may correspond to at least one of an NLRI attribute or an MP_REACH_NLRI attribute. In many additional examples, the second attribute may correspond to a BGP tunnel encapsulation attribute. Specifically, the second attribute may correspond to a Tunnel Egress Endpoint field included in the BGP tunnel encapsulation attribute.

In several embodiments, the process 500 may transmit the plurality of route advertisements (block 550). In an example, the plurality of route advertisements may be transmitted to the second VTEP and/or the third VTEP of the network fabric. In many examples, the transmission of the plurality of route advertisements may enable the second VTEP (and/or the third VTEP) to update a flood list associated with the second VTEP (and/or the third VTEP). In an example, since the plurality of route advertisements has the same originating router address during the BGP session, a route key associated with the first VTEP to remain consistent (or same) during the BGP session. As a result, the second VTEP (and/or the third VTEP) may update corresponding flood list to modify an existing list of addresses of the first VTEP rather than adding addresses included in the plurality of route advertisements as a new list of addresses.

Although a specific embodiment of the process 500 for carrying out the various steps, processes, methods, and operations described herein is discussed with respect to FIG. 5, any of a variety of systems and/or processes may be utilized in accordance with embodiments of the disclosure. For example, the process 500 may determine a prioritized underlay network configuration among the first underlay network configuration and the second underlay network configuration. Further, the process 500 may determine the primary and secondary next-hop addresses based on the prioritized underlay network configuration. The elements depicted in FIG. 5 may also be interchangeable with other elements of FIGS. 1-4 and 6-11 as required to realize a particularly desired embodiment.

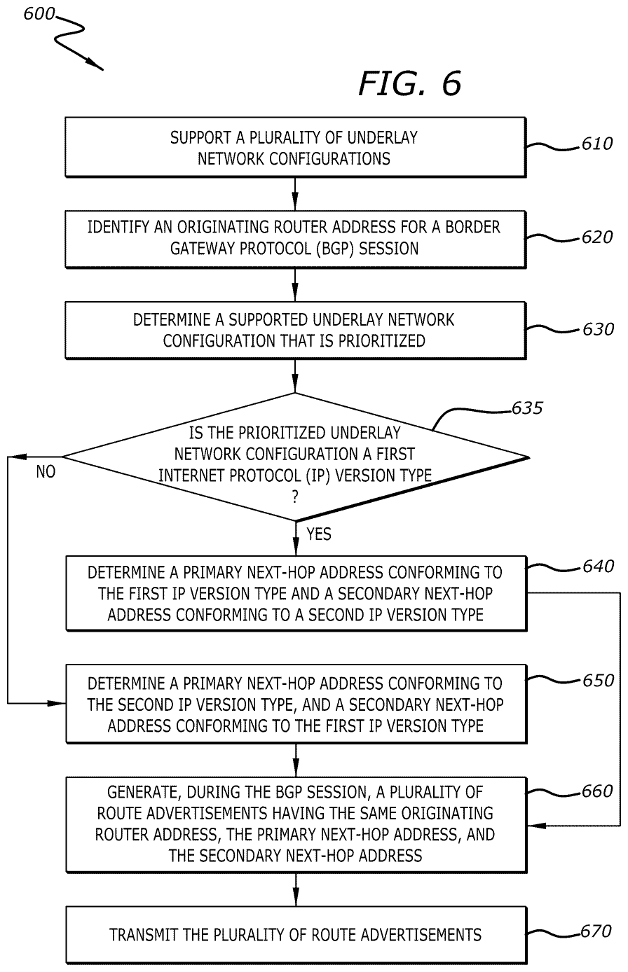

Referring to FIG. 6, a flowchart depicting a process 600 for transmitting a plurality of route advertisements in accordance with various embodiments of the disclosure is shown. In numerous embodiments, the process 600 may be implemented within a network fabric. In various examples, the network fabric may include multiple VTEPs. For example, each VTEP of the network fabric may correspond to a network device (e.g., a switch, a router, or the like) that encapsulates (and/or decapsulates) Layer 2 frames into VXLAN packets for transmission over an IP-based underlay network. In an example, the network fabric may include a first VTEP and a second VTEP. In numerous additional embodiments, at least one VTEP of the network fabric may establish a BGP session to migrate the network fabric from a first IP version type transport to a second IP type transport. For example, the first VTEP may establish the BGP session. In an example, the process 600 may be implemented by the first VTEP within the established BGP session.

In many embodiments, the process 600 may support a plurality of underlay network configurations (block 610). In many examples, the plurality of underlay network configurations may include a first underlay network configuration associated with a first IP version type and a second underlay network configuration associated with a second IP version type. For example, the first IP version type may correspond to one of an IPv4 protocol or an IPv6 protocol. The second IP version type may correspond to the remaining one of the IPv4 protocol or the IPv6 protocol. As used herein, the first underlay network configuration may correspond to a first set of configurational parameters that enables the process 600 to perform a first IP version type VXLAN encapsulation scheme (and/or a first IP version type VXLAN decapsulation scheme) by defining the first IP version type addresses, VNIs, and UDP port numbers necessary for establishing VXLAN tunnels. As used herein, the second underlay network configuration may correspond to a second set of configurational parameters that enables the process 600 to perform a second IP version type VXLAN encapsulation scheme (and/or a second IP version type VXLAN decapsulation scheme) by defining the second IP version type addresses, VNIs, and UDP port numbers necessary for establishing VXLAN tunnels.

In more embodiments, the process 600 may identify an originating router address for the BGP session (block 620). In various examples, the originating router address may correspond to a router identifier associated with the first VTEP. In numerous examples, in order to identify the originating router address, the process 600 may determine whether the originating router address associated with the first VTEP exists for the BGP session. In an example, if the originating router address exists, the process 600 may identify, as the originating router address, the same originating router address that exists for the BGP session. Conversely, if the originating router address does not exist, the process 600 may identify the originating router address based on an existing IPv4 address and/or an existing IPv6 address associated with the first VTEP. For example, the originating router address may conform to one of the first IP version type or the second IP version type.

In still more embodiments, the process 600 may determine the supported underlay network configuration that is prioritized for routing (block 630). In various examples, the process 600 may determine, among the first underlay network configuration and the second underlay network configuration, the prioritized underlay network configuration for routing. In an example, the prioritized underlay network configuration may be determined based on an underlay network configuration supported by the second VTEP. For example, if the second VTEP supports the first underlay network configuration, the process 600 may determine the first underlay network configuration as the prioritized underlay network configuration. Conversely, if the second VTEP supports the second underlay network configuration, the process 600 may determine the second underlay network configuration as the prioritized underlay network configuration.

In yet more embodiments, the process 600 may determine whether the prioritized underlay network configuration corresponds to the first IP version type (block 635). For example, if the prioritized underlay network configuration corresponds to the first underlay network configuration, the process 600 may determine that the prioritized underlay network configuration corresponds to the first IP version type. Conversely, if the prioritized underlay network configuration corresponds to the second underlay network configuration, the process 600 may determine that the prioritized underlay network configuration does not correspond to the first IP version type. In still yet more embodiments, if the prioritized underlay network configuration corresponds to the first IP version type, the process 600 may determine a primary next-hop address conforming to the first IP version type and a secondary next-hop address conforming to the second IP version type (block 640). For example, the primary and secondary next-hop addresses may correspond to IPv4 and IPv6 addresses of the first VTEP, respectively.

In additional embodiments, if the prioritized underlay network configuration does not correspond to the first IP version type, the process 600 may determine a primary next-hop address conforming to the second IP version type and a secondary next-hop address conforming to the first IP version type (block 650). For example, if the second IP version type corresponds to the IPv6 protocol, the process 600 may determine, as the primary and secondary next-hop addresses, the IPv6 and IPv4 addresses of the first VTEP, respectively. Conversely, if the second IP version type corresponds to the IPv4 protocol, the process 600 may determine, as the primary and secondary next-hop addresses, the IPv4 and IPv6 addresses of the first VTEP, respectively.

In still additional embodiments, the process 600 may generate, during the BGP session, the plurality of route advertisements having the same originating router address, the primary next-hop address, and the secondary next-hop address (block 660). In various examples, the plurality of route advertisements may correspond to a plurality of BGP route update advertisement. In numerous examples, the primary next-hop address and the secondary next-hop address may be included in a first attribute and a second attribute of each of the plurality of BGP route update advertisements, respectively. In an example, the first attribute may correspond to an NLRI attribute or an MP_REACH_NLRI attribute. The second attribute may correspond to a BGP tunnel encapsulation attribute.

In still yet additional embodiments, the process 600 may transmit the plurality of route advertisements (block 670). In an example, the plurality of route advertisements may be transmitted to the second VTEP. In many examples, the transmission of the plurality of route advertisements may enable the second VTEP to update a flood list associated with the second VTEP. Further, the updated flood list may be utilized by the second VTEP to transmit one or more VXLAN-encapsulated data packets to the first VTEP.

Although a specific embodiment of the process 600 for carrying out the various steps, processes, methods, and operations described herein is discussed with respect to FIG. 6, any of a variety of systems and/or processes may be utilized in accordance with embodiments of the disclosure. For example, the process 600 may receive an update request for updating a set of configuration parameters associated with the first VTEP. Further, the process 600 may support the plurality of underlay network configurations based on the reception of the update request. The elements depicted in FIG. 6 may also be interchangeable with other elements of FIGS. 1-5 and 7-11 as required to realize a particularly desired embodiment.

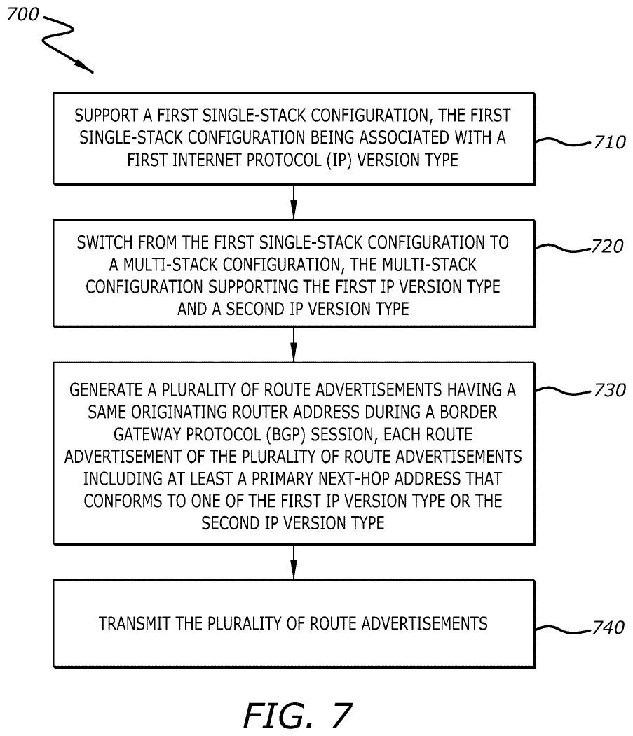

Referring to FIG. 7, a flowchart depicting a process 700 for switching from a first single-stack configuration to a multi-stack configuration in accordance with various embodiments of the disclosure is shown. In numerous embodiments, the process 700 may be implemented within a network fabric. In various examples, the network fabric may include multiple VTEPs. For example, the network fabric may include a first VTEP and a second VTEP. In numerous additional embodiments, at least one VTEP of the network fabric may implement the process 700. For example, the first VTEP may implement the process 700.

In many embodiments, the process 700 may support the first single-stack configuration (block 710). In various examples, the first single-stack configuration may correspond to a first underlay network configuration that is associated with a first IP version type. For example, the first IP version type may correspond to one of an IPv4 protocol or an IPv6 protocol. In numerous examples, the first single-stack configuration may correspond to a first set of configurational parameters that enables the process 700 to perform a first IP version type VXLAN encapsulation scheme (and/or a first IP version type VXLAN decapsulation scheme) by defining the first IP version type addresses, VNIs, and UDP port numbers necessary for establishing VXLAN tunnels. Upon supporting the first single-stack configuration, the process 700 may establish a BGP session. In an example, the BGP session may be established with the second VTEP. In various examples, the BGP session may be established for advertising one or more EVPN routes associated with the first VTEP. In some more examples, the BGP session may be established for migrating the network fabric from the first IP version type transport to the second IP version type transport.

In many further embodiments, upon establishing the BGP session, the process 700 may determine an originating router address associated with the first VTEP. In numerous examples, the originating router address may be determined based on an existing IPv4 address and/or an existing IPv6 address associated with the first VTEP. In various examples, the originating router address may conform to one of the first IP version type or a second IP version type. For example, the second IP version type may be different from the first IP version type. In an example, if the first IP version type corresponds to the IPv4 protocol, the second IP version type may correspond to the IPv6 protocol.

In many additional embodiments, upon determining the originating router address, the process 700 may generate at least one route advertisement. For example, the route advertisement may include the determined originating router address and a single next-hop address of the first VTEP. In an example, the single next-hop address may conform to the first IP version type. Upon generating the route advertisement, the process 700 may broadcast the route advertisement. For example, the process 700 may transmit the route advertisement to the second VTEP. In an example, the transmission of the route advertisement may enable the network fabric to perform the first IP version type transport.

In more embodiments, the process 700 may switch from the first single-stack configuration to the multi-stack configuration (block 720). In numerous examples, the process 700 may switch from the first single-stack configuration to the multi-stack configuration based on the reception of an update request for updating a set of configurational parameters associated with the first VTEP. In an example, the update request may be provided by a network operator, an administrator, or the like. In various examples, the multi-stack configuration may include the first underlay network configuration associated with the first IP version type and a second underlay network configuration associated with the second IP version type. For example, the second underlay network configuration may correspond to a second set of configurational parameters that enables the process 700 to perform a second IP version type VXLAN encapsulation scheme (and/or a second IP version type VXLAN decapsulation scheme) by defining second IP version type addresses, the VNIs, and the UDP port numbers necessary for establishing VXLAN tunnels.

In still more embodiments, upon switching to the multi-stack configuration, the process 700 may identify the originating router address associated with the first VTEP. In various examples, to identify the originating router address, the process 700 may determine whether the originating router address for the first VTEP was previously determined during the BGP session. In an example, if the originating router address was previously determined, the process 700 may identify the same originating router address for the first VTEP that was previously determined during the BGP session. Conversely, if the originating router address is absent, the process 700 may identify the originating router address based on the existing IPv4 address and/or the existing IPv6 address associated with the first VTEP.

In yet more embodiments, upon identifying the originating router address, the process 700 may determine a primary next-hop address and a secondary next-hop address associated with the first VTEP. In various examples, the primary next-hop address may conform to one of the first IP version type or the second IP version type. The secondary next-hop address may conform to the remaining one of the first IP version type or the second IP version type. In numerous examples, the primary and secondary next-hop addresses may be determined in such a way that an IP version type of the primary and/or secondary next-hop addresses is independent of an IP version type of the originating router address.

In additional embodiments, the process 700 may generate a plurality of route advertisements having the same originating router address during the BGP session (block 730). In various examples, the plurality of route advertisements may correspond to a plurality of BGP route update advertisements. In numerous examples, each route advertisement of the plurality of route advertisements may include the identified originating router address and the primary next-hop address that conforms to one of the first IP version type or the second IP version type. In numerous additional examples, each route advertisement of the plurality of route advertisements may further include the secondary next-hop address that conforms to the remaining one of the first IP version type or the second IP version type.

In still additional embodiments, the process 700 may transmit the plurality of route advertisements (block 740). In an example, the plurality of route advertisements may be transmitted to the second VTEP. In various examples, the transmission of the plurality of route advertisements may enable the second VTEP to update a flood list associated with the second VTEP. Further, the updated flood list may be utilized by the second VTEP to transmit one or more VXLAN-encapsulated data packets to the first VTEP.

Although a specific embodiment of the process 700 for carrying out the various steps, processes, methods, and operations described herein is discussed with respect to FIG. 7, any of a variety of systems and/or processes may be utilized in accordance with embodiments of the disclosure. For example, the switching of the first VTEP from the first single-stack configuration to the multi-stack configuration may be based on one or more triggers. In an example, the triggers may include a failure of a first IP version type connectivity or reception of one or more route advertisements from peers that include second IP version type transport information, or the like. The elements depicted in FIG. 7 may also be interchangeable with other elements of FIGS. 1-6 and 8-11 as required to realize a particularly desired embodiment.

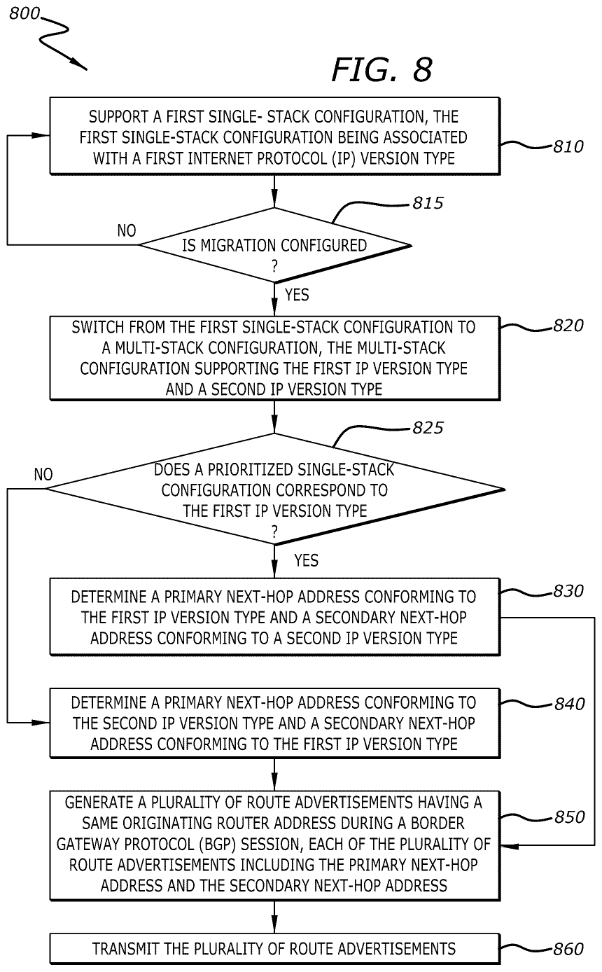

Referring to FIG. 8, a flowchart depicting a process 800 for switching from a first single-stack configuration to a multi-stack configuration in accordance with various embodiments of the disclosure is shown. In numerous embodiments, the process 800 may be implemented within a network fabric. In various examples, the network fabric may include multiple VTEPs. For example, the network fabric may include a first VTEP and a second VTEP. In numerous additional embodiments, at least one VTEP of the network fabric may implement the process 800. For example, the first VTEP may implement the process 800.

In many embodiments, the process 800 may support the first single-stack configuration (block 810). In various examples, the first single-stack configuration may correspond to a first underlay network configuration that is associated with a first IP version type. For example, the first IP version type may correspond to one of an IPv4 protocol or an IPv6 protocol. In numerous examples, the first single-stack configuration may correspond to a first set of configurational parameters that enables the process 800 to perform a first IP version type VXLAN encapsulation scheme (and/or a first IP version type VXLAN decapsulation scheme) by defining the first IP version type addresses, VNIs, and UDP port numbers necessary for establishing VXLAN tunnels.

In many additional embodiments, upon supporting the first single-stack configuration, the process 800 may establish a BGP session. In an example, the BGP session may be established with the second VTEP. In various examples, the BGP session may be established for advertising one or more EVPN routes associated with the first VTEP. In some more examples, the BGP session may be established for migrating the first VTEP from the first IP version type transport to the second IP version type transport.

In many further embodiments, upon establishing the BGP session, the process 800 may transmit at least one route advertisement within the BGP session. In various examples, in order to transmit the route advertisement, the process 800 may determine an originating router address associated with the first VTEP. In an example, the originating router address may correspond to a router identifier associated with the first VTEP. In numerous examples, the originating router address may conform to one of the first IP version type or a second IP version type. For example, the second IP version type may be different from the first IP version type. Upon determining the originating router address, the process 800 may generate the route advertisement that includes the determined originating router address and a single next-hop address of the first VTEP. Further, the process 800 may transmit the generated route advertisement for advertising the EVPN routes associated with the first VTEP.

In more embodiments, the process 800 may determine whether the migration of the first VTEP is configured (block 815). In various examples, the process 800 may determine whether the migration of the first VTEP is configured based on the reception of an update request for updating the set of configuration parameters associated with the first VTEP. In an example, the process 800 may determine that the migration of the first VTEP is configured, if the process 800 receives the update request. Conversely, if the process 800 does not receive the update request, the process 800 may determine that the migration of the first VTEP is not configured. In still more embodiments, if the migration of the first VTEP is not configured, the process 800 may continue with supporting the first single-stack configuration (block 810).

In yet more embodiments, if the migration of the first VTEP is configured, the process 800 may switch from the first single-stack configuration to the multi-stack configuration (block 820). In numerous examples, the multi-stack configuration may support both the first IP version type and the second IP version type. In an example, the multi-stack configuration may include the first underlay network configuration associated with the first IP version type and a second underlay network configuration associated with the second IP version type. For example, the second underlay network configuration may correspond to a second set of configurational parameters that enables the process 800 to perform a second IP version type VXLAN encapsulation scheme (and/or a second IP version type VXLAN decapsulation scheme) by defining second IP version type addresses, the VNIs, and the UDP port numbers necessary for establishing VXLAN tunnels.

In still yet more embodiments, upon switching to the multi-stack configuration, the process 800 may identify the originating router address associated with the first VTEP. In various examples, to identify the originating router address, the process 800 may determine whether the originating router address for the first VTEP was previously determined during the BGP session. In an example, if the originating router address was previously determined, the process 800 may identify the same originating router address for the first VTEP that was previously determined during the BGP session. Conversely, if the originating router address is absent, the process 800 may identify the originating router address based on an existing IPv4 address and/or an existing IPv6 address associated with the first VTEP.

In further embodiments, upon identifying the originating router address, the process 800 may determine, among the first underlay network configuration and the second underlay network configuration, a prioritized underlay network configuration for routing. In an example, the prioritized underlay network configuration may be determined based on an underlay network configuration supported by the second VTEP. For example, if the second VTEP supports the first underlay network configuration, the process 800 may determine the first underlay network configuration as the prioritized underlay network configuration. Conversely, if the second VTEP supports the second underlay network configuration, the process 800 may determine the second underlay network configuration as the prioritized single-stack configuration.

In still further embodiments, the process 800 may determine whether the prioritized underlay network configuration corresponds to the first IP version type (block 825). For example, if the prioritized underlay network configuration corresponds to the first underlay network configuration, the process 800 may determine that the prioritized underlay network configuration corresponds to the first IP version type. Conversely, if the prioritized underlay network configuration corresponds to the second underlay network configuration, the process 800 may determine that the prioritized underlay network configuration does not correspond to the first IP version type. In still yet further embodiments, if the prioritized underlay network configuration corresponds to the first IP version type, the process 800 may determine a primary next-hop address conforming to the first IP version type and a secondary next-hop address conforming to the second IP version type (block 830). For example, the primary and secondary next-hop addresses may correspond to IPv4 and IPv6 addresses of the first VTEP.

In additional embodiments, if the prioritized underlay network configuration does not correspond to the first IP version type, the process 800 may determine a primary next-hop address conforming to the second IP version type and a secondary next-hop address conforming to the first IP version type (block 840). For example, if the first IP version type corresponds to the IPv4 protocol, the process 800 may determine, as the primary and secondary next-hop addresses, the IPv6 and IPv4 addresses of the first VTEP, respectively. Conversely, if the first IP version type corresponds to the IPv6 protocol, the process 800 may determine, as the primary and secondary next-hop addresses, the IPv4 and IPv6 addresses of the first VTEP, respectively.

In still additional embodiments, the process 800 may generate a plurality of route advertisements having the same originating router address during the BGP session (block 850). In various examples, each route advertisement of the plurality of route advertisements may include the identified originating router address and the primary and secondary next-hop addresses. In numerous examples, the plurality of route advertisements may correspond to a plurality of BGP route update advertisements. In numerous additional examples, the primary next-hop address and the secondary next-hop address may be included in a first attribute and a second attribute of each of the plurality of BGP route update advertisements, respectively. In an example, the first attribute may correspond to an NLRI attribute or an MP_REACH_NLRI attribute. The second attribute may correspond to a BGP tunnel encapsulation attribute.

In still additional embodiments, the process 800 may transmit the plurality of route advertisements (block 860). In an example, the plurality of route advertisements may be transmitted to the second VTEP. In various examples, the transmission of the plurality of route advertisements may enable the second VTEP to update a flood list associated with the second VTEP. Further, the updated flood list may be utilized by the second VTEP to transmit one or more VXLAN-encapsulated data packets to the first VTEP.

Although a specific embodiment of the process 800 for carrying out the various steps, processes, methods, and operations described herein is discussed with respect to FIG. 8, any of a variety of systems and/or processes may be utilized in accordance with embodiments of the disclosure. For example, upon transmitting the plurality of route advertisements, the process 800 may further switch from the multi-stack configuration to the second single-stack configuration. The elements depicted in FIG. 8 may also be interchangeable with other elements of FIGS. 1-7 and 9-11 as required to realize a particularly desired embodiment.

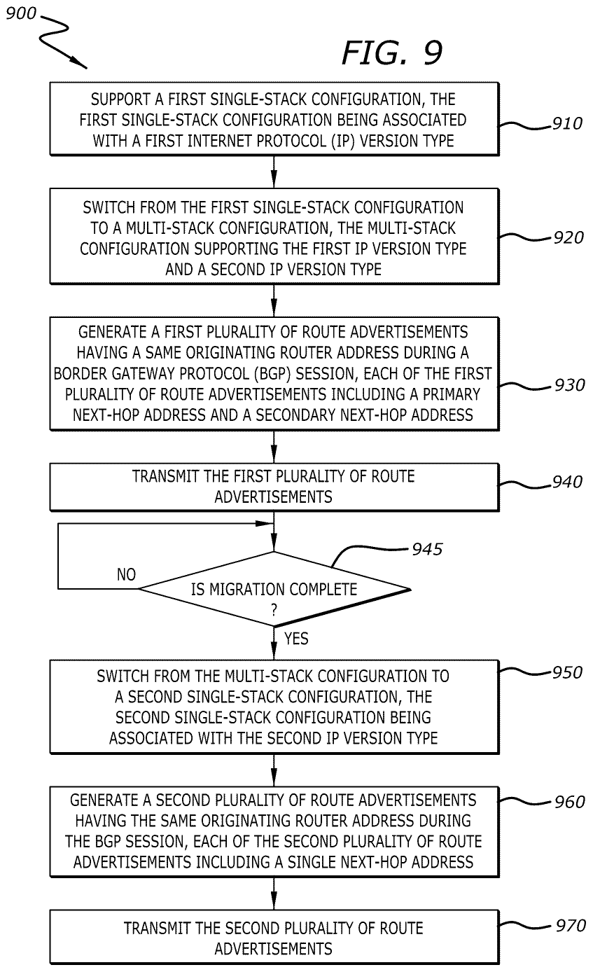

Referring to FIG. 9, a flowchart depicting a process 900 for migrating from a first single-stack configuration to a second single-stack configuration in accordance with various embodiments of the disclosure is shown. In numerous embodiments, the process 900 may be implemented within a network fabric. In various examples, the network fabric may include multiple VTEPs. For example, the network fabric may include a first VTEP and a second VTEP. In numerous additional embodiments, at least one VTEP of the network fabric may implement the process 900. For example, the first VTEP may implement the process 900.

In many embodiments, the process 900 may support the first single-stack configuration (block 910). In various examples, the first single-stack configuration may correspond to a first underlay network configuration that is associated with a first IP version type. For example, the first IP version type may correspond to one of an IPv4 protocol or an IPv6 protocol. In numerous examples, the first single-stack configuration may correspond to a first set of configurational parameters that enables the process 900 to perform a first IP version type VXLAN encapsulation scheme (and/or a first IP version type VXLAN decapsulation scheme) by defining the first IP version type addresses, VNIs, and UDP port numbers necessary for establishing VXLAN tunnels.

In many additional embodiments, upon supporting the first single-stack configuration, the process 900 may establish a BGP session. In an example, the BGP session may be established with the second VTEP. In various examples, the BGP session may be established for advertising one or more EVPN routes associated with the first VTEP. In some more examples, the BGP session may be established for migrating the first VTEP from the first IP version type transport to the second IP version type transport.

In many further embodiments, upon establishing the BGP session, the process 900 may transmit at least one route advertisement within the BGP session. In various examples, in order to transmit the route advertisement, the process 900 may determine an originating router address associated with the first VTEP. In an example, the originating router address may be determined based on an existing IPv4 address and/or an existing IPv6 address associated with the first VTEP. In numerous examples, the originating router address may conform to one of the first IP version type or a second IP version type. For example, the second IP version type may be different from the first IP version type. Upon determining the originating router address, the process 900 may generate the route advertisement that includes the determined originating router address and a first single next-hop address of the first VTEP. In an example, the first single next-hop address of the first VTEP may conform to the first IP version type. Further, the process 900 may transmit the generated route advertisement for advertising the EVPN routes associated with the first VTEP.

In more embodiments, the process 900 may switch from the first single-stack configuration to the multi-stack configuration (block 920). In numerous examples, the process 900 may switch from the first single-stack configuration to the multi-stack configuration based on the reception of an update request for updating a set of configurational parameters associated with the first VTEP. In various examples, the multi-stack configuration may include the first underlay network configuration associated with the first IP version type and a second underlay network configuration associated with the second IP version type. For example, the second underlay network configuration may correspond to a second set of configurational parameters that enables the process 900 to perform a second IP version type VXLAN encapsulation scheme (and/or a second IP version type VXLAN decapsulation scheme) by defining second IP version type addresses, the VNIs, and the UDP port numbers necessary for establishing VXLAN tunnels.

In still more embodiments, upon switching to the multi-stack configuration, the process 900 may identify the originating router address associated with the first VTEP. In various examples, to identify the originating router address, the process 900 may determine whether the originating router address was previously determined for the first VTEP during the BGP session. In an example, if the originating router address was previously determined, the process 900 may identify the same originating router address that was previously determined for the first VTEP during the BGP session. Conversely, if the originating router address is absent, the process 900 may identify the originating router address based on the existing IPv4 address and/or the existing IPv6 address associated with the first VTEP.

In yet more embodiments, upon identifying the originating router address, the process 900 may determine a primary next-hop address and a secondary next-hop address associated with the first VTEP. In numerous examples, the primary and secondary next-hop addresses may be determined in such a way that an IP version type of the primary and/or secondary next-hop addresses is independent of an IP version type of the originating router address. In an example, the primary and secondary next-hop addresses may correspond to the IPv4 and IPv6 addresses of the first VTEP.

In additional embodiments, the process 900 may generate a first plurality of route advertisements having the same originating router address during the BGP session (block 930). In various examples, the first plurality of route advertisements may correspond to a first plurality of BGP route update advertisements. In numerous examples, each route advertisement of the first plurality of route advertisements may include the identified originating router address, the determined primary next-hop address, and the determined secondary next-hop address.

In still additional embodiments, the process 900 may transmit the first plurality of route advertisements (block 940). In an example, the first plurality of route advertisements may be transmitted to the second VTEP. In various examples, the transmission of the first plurality of route advertisements may enable the second VTEP to transmit one or more VXLAN-encapsulated data packets to the first VTEP by utilizing at least one of the primary or secondary next-hop addresses of the first VTEP.

In still yet additional embodiments, the process 900 may determine whether the migration of the first VTEP from the first IP version type transport to the second IP version type transport is completed (block 945). In numerous examples, if all VTEPs associated with the first VTEP support the second underlay network configuration, the process 900 may determine that the migration of the first VTEP is completed. For example, if the second VTEP supports the second underlay network configuration, the process 900 may determine that the migration of the first VTEP is completed. Conversely, if the second VTEP does not support the second underlay network configuration, the process 900 may determine that the migration of the first VTEP is not completed. In a number of embodiments, if the migration of the first VTEP is not completed, the process 900 may wait for a predefined time. Further, the process 900 may again determine whether the migration of the first VTEP is completed (block 945).

In further additional embodiments, if the migration of the first VTEP is completed, the process 900 may switch from the multi-stack configuration to a second single-stack configuration (block 950). For example, the second single-stack configuration may correspond to the second underlay network configuration that is associated with the second IP version type. In an example, the switching of the first VTEP from the multi-stack configuration to the second single-stack configuration may include updating the set of configuration parameters associated with first VTEP to the second set of configuration parameters. In further embodiments, upon switching to the second single-stack configuration, the process 900 may identify the originating router address associated with the first VTEP. In various examples, the process 900 may identify, as the originating router address, the same originating router address that was previously determined for the first VTEP during the BGP session. In still further embodiments, upon identifying the originating router address, the process 900 may determine a second single next-hop address associated with the first VTEP. In an example, the second single next-hop address may conform to the second IP version type.

In several embodiments, the process 900 may generate a second plurality of route advertisements having the same originating router address during the BGP session (block 960). In various examples, the second plurality of route advertisements may correspond to a second plurality of BGP route update advertisements. In numerous examples, each route advertisement of the second plurality of route advertisements may include the identified originating router address and the determined second single next-hop address.

In several more embodiments, the process 900 may transmit the second plurality of route advertisements (block 970). In an example, the second plurality of route advertisements may be transmitted to the second VTEP. In various examples, the transmission of the second plurality of route advertisements may enable the second VTEP to transmit one or more VXLAN-encapsulated data packets to the first VTEP by utilizing the second single next-hop address of the first VTEP.

Although a specific embodiment of the process 900 for carrying out the various steps, processes, methods, and operations described herein is discussed with respect to FIG. 9, any of a variety of systems and/or processes may be utilized in accordance with embodiments of the disclosure. For example, the process 900 may further receive one or more route advertisements from the second VTEP and update a flood list associated with the first VTEP based on the received route advertisements. The elements depicted in FIG. 9 may also be interchangeable with other elements of FIGS. 1-8 and 10-11 as required to realize a particularly desired embodiment.

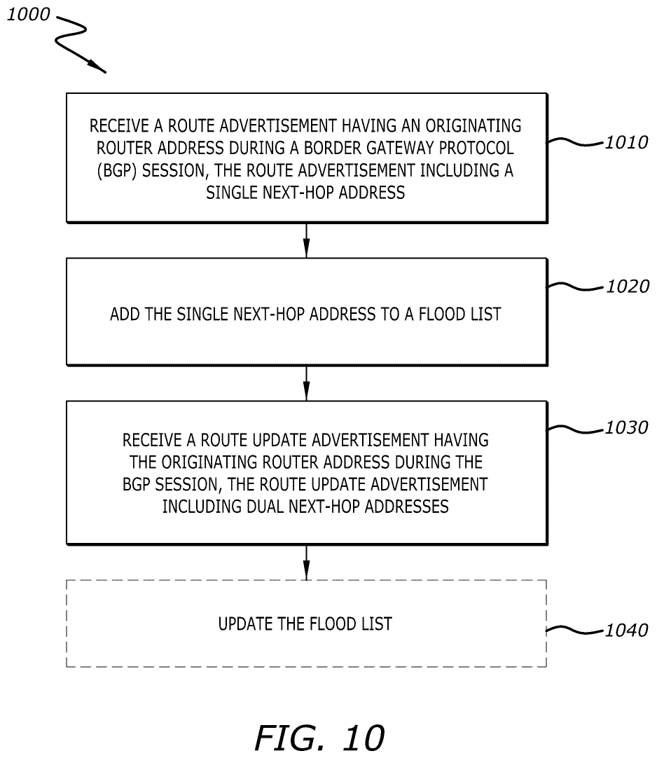

Referring to FIG. 10, a flowchart depicting a process 1000 for receiving one or more route advertisements in accordance with various embodiments of the disclosure is shown. In numerous embodiments, the process 1000 may be implemented within a network fabric. In various examples, the network fabric may include multiple VTEPs. For example, the network fabric may include a first VTEP and a second VTEP. In numerous additional embodiments, at least one VTEP of the network fabric may implement the process 1000. For example, the first VTEP may implement the process 1000.

In many embodiments, the process 1000 may receive a route advertisement having an originating router address during a BGP session (block 1010). For example, the process 1000 may receive the route advertisement from the second VTEP. In an example, the route advertisement may correspond to a BGP route advertisement. In various examples, the route advertisement may include the originating router address of the second VTEP and a single next-hop address of the second VTEP. For example, the originating router address may correspond to a router identifier of the second VTEP. In an example, the size of the originating router address may correspond to one of four octets or sixteen octets. In numerous examples, the single next-hop address may correspond to one of an IPv4 address or an IPv6 address of the second VTEP.

In many additional embodiments, the process 1000 may add the single next-hop address to a flood list (block 1020). In an example, the flood list may be associated with the first VTEP. In numerous examples, in order to add the single next-hop address, the process 1000 may determine whether a list of addresses for the second VTEP exists in the flood list based on the originating router address included in the route advertisement. In an example, if the list of addresses does not exist, the process 1000 may add, as a new list of addresses for the second VTEP, the single next-hop address in the flood list. Conversely, if the list of addresses exists, the process 1000 may replace one or more existing addresses of the second VTEP with the single next-hop address.

In further embodiments, the process 1000 may receive a route update advertisement having the originating router address during the BGP session (block 1030). For example, the process 1000 may receive the route update advertisement from the second VTEP. In an example, the route update advertisement may correspond to a BGP route update advertisement. In various examples, the route update advertisement may include the originating router address of the second VTEP and dual next-hop addresses of the second VTEP. In numerous examples, the dual next-hop addresses may correspond to the IPv4 and IPv6 addresses of the second VTEP. In many examples, the originating router address included in the route update advertisement may be the same originating router address included in the route advertisement.

In several embodiments, the process 1000 may update the flood list (block 1040). In several examples, in order to update the flood list, the process 1000 may determine whether the list of addresses for the second VTEP exists in the flood list based on the originating router address included in the route update advertisement. In an example, if the list of addresses does not exist, the process 1000 may add, as a new list of addresses for the second VTEP, the dual next-hop addresses in the flood list. Conversely, if the list of addresses exists, the process 1000 may replace the existing addresses of the second VTEP with the dual next-hop addresses. In further embodiments, updating the flood list may be optional.

Although a specific embodiment of the process 1000 for carrying out the various steps, processes, methods, and operations described herein is discussed with respect to FIG. 10, any of a variety of systems and/or processes may be utilized in accordance with embodiments of the disclosure. For example, the process 1000 may transmit one or more VXLAN-encapsulated data packets to the second VTEP based on the flood list associated with the first VTEP. The elements depicted in FIG. 10 may also be interchangeable with other elements of FIGS. 1-9 and 11 as required to realize a particularly desired embodiment.

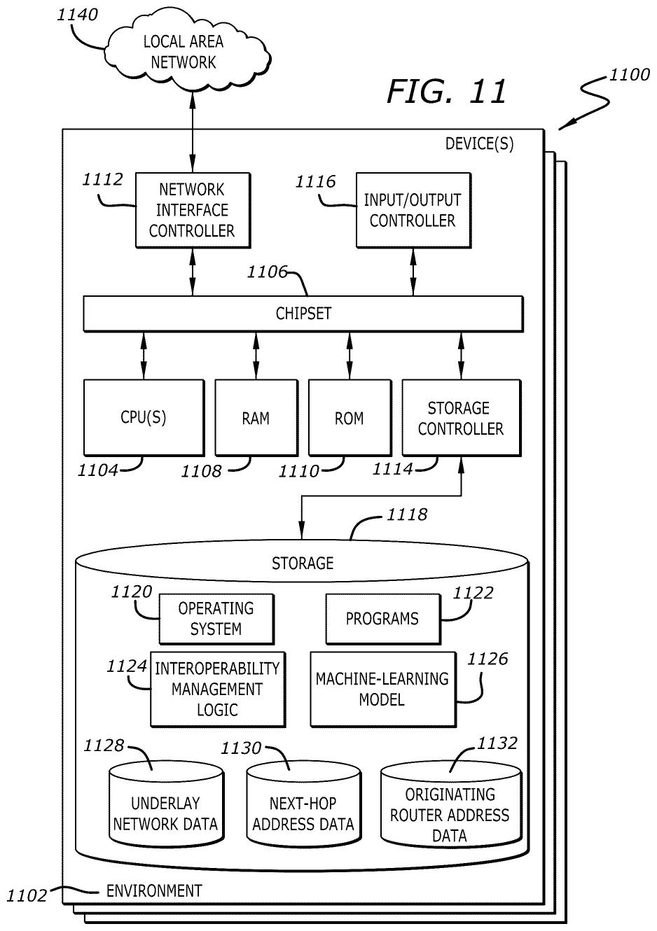

Referring to FIG. 11, a conceptual block diagram of a device 1100 suitable for configuration with an interoperability management logic in accordance with various embodiments of the disclosure is shown. The embodiment of the conceptual block diagram depicted in FIG. 11 can illustrate a conventional server, computer, workstation, desktop computer, laptop, tablet, network appliance, e-reader, smartphone, or other computing device, and can be utilized to execute any of the application or logic components presented herein. The embodiment of the conceptual block diagram depicted in FIG. 11 can also illustrate an access point, a switch, or a router in accordance with various embodiments of the disclosure. The device 1100 may, in many non-limiting examples, correspond to physical devices or to virtual resources described herein.

In many embodiments, the device 1100 (e.g., a multi-stack capable device) may include an environment 1102 such as a baseboard or “motherboard,” in physical embodiments that can be configured as a printed circuit board with a multitude of components or devices connected by way of a system bus or other electrical communication paths. Conceptually, in virtualized embodiments, the environment 1102 may be a virtual environment that encompasses and executes the remaining components and resources of the device 1100. In more embodiments, one or more processors 1104, such as, but not limited to, central processing units (“CPUs”) can be configured to operate in conjunction with a chipset 1106. The processor(s) 1104 can be standard programmable CPUs that perform arithmetic and logical operations necessary for the operation of the device 1100.

In a number of embodiments, the processor(s) 1104 can perform one or more operations by transitioning from one discrete, physical state to the next through the manipulation of switching elements that differentiate between and change these states. Switching elements generally include electronic circuits that maintain one of two binary states, such as flip-flops, and electronic circuits that provide an output state based on the logical combination of the states of one or more other switching elements, such as logic gates. These basic switching elements can be combined to create more complex logic circuits, including registers, adders-subtractors, arithmetic logic units, floating-point units, and the like.

In various embodiments, the chipset 1106 may provide an interface between the processor(s) 1104 and the remainder of the components and devices within the environment 1102. The chipset 1106 can provide an interface to a random-access memory (“RAM”) 1108, which can be used as the main memory in the device 1100 in some embodiments. The chipset 1106 can further be configured to provide an interface to a computer-readable storage medium such as a read-only memory (“ROM”) 1110 or non-volatile RAM (“NVRAM”) for storing basic routines that can help with various tasks such as, but not limited to, starting up the device 1100 or transferring information between the various components and devices. The ROM 1110 or NVRAM can also store other application components necessary for the operation of the device 1100 in accordance with various embodiments described herein.

Additional embodiments of the device 1100 can be configured to operate in a networked environment using logical connections to remote computing devices and computer systems through a network, such as the network 1140. The chipset 1106 can include functionality for providing network connectivity through a network interface card (“NIC”) 1112, which may comprise a gigabit Ethernet adapter or similar component. The NIC 1112 can be capable of connecting the device 1100 to other devices over the network 1140. It is contemplated that multiple NICs 1112 may be present in the device 1100, connecting the device to other types of networks and remote systems.

In further embodiments, the device 1100 can be connected to a storage 1118 that provides non-volatile storage for data accessible by the device 1100. The storage 1118 can, for instance, store an operating system 1120, programs 1122, underlay network data 1128, next-hop address data 1130, and originating router address data 1132 which are described in greater detail below. The storage 1118 can be connected to the environment 1102 through a storage controller 1114 connected to the chipset 1106. In certain embodiments, the storage 1118 can consist of one or more physical storage units. The storage controller 1114 can interface with the physical storage units through a serial attached SCSI (“SAS”) interface, a serial advanced technology attachment (“SATA”) interface, a fiber channel (“FC”) interface, or other type of interface for physically connecting and transferring data between computers and physical storage units.

The device 1100 can store data within the storage 1118 by transforming the physical state of the physical storage units to reflect the information being stored. The specific transformation of physical state can depend on various factors. Examples of such factors can include, but are not limited to, the technology used to implement the physical storage units, whether the storage 1118 is characterized as primary or secondary storage, and the like.

In still more embodiments, the device 1100 can store information within the storage 1118 by issuing instructions through the storage controller 1114 to alter the magnetic characteristics of a particular location within a magnetic disk drive unit, the reflective or refractive characteristics of a particular location in an optical storage unit, or the electrical characteristics of a particular capacitor, transistor, or other discrete component in a solid-state storage unit, or the like. Other transformations of physical media are possible without departing from the scope and spirit of the present description, with the foregoing examples provided only to facilitate this description. The device 1100 can further read or access information from the storage 1118 by detecting the physical states or characteristics of one or more particular locations within the physical storage units.

In addition to the storage 1118 described above, the device 1100 can have access to other computer-readable storage media to store and retrieve information, such as program modules, data structures, or other data. It should be appreciated by those skilled in the art that computer-readable storage media is any available media that provides for the non-transitory storage of data and that can be accessed by the device 1100. In some examples, the operations performed by a cloud computing network, and or any components included therein, may be supported by one or more devices similar to device 1100. Stated otherwise, some or all of the operations performed by the cloud computing network, and or any components included therein, may be performed by one or more devices 1100 operating in a cloud-based arrangement.

By way of example, and not limitation, computer-readable storage media can include volatile and non-volatile, removable and non-removable media implemented in any method or technology. Computer-readable storage media includes, but is not limited to, RAM, ROM, erasable programmable ROM (“EPROM”), electrically-erasable programmable ROM (“EEPROM”), flash memory or other solid-state memory technology, compact disc ROM (“CDROM”), digital versatile disk (“DVD”), high definition DVD (“HD-DVD”), BLU-RAY, or other optical storage, magnetic cassettes, magnetic tape, magnetic disk storage or other magnetic storage devices, or any other medium that can be used to store the desired information in a non-transitory fashion.

As mentioned briefly above, the storage 1118 can store an operating system 1120 utilized to control the operation of the device 1100. According to one embodiment, the operating system comprises the LINUX operating system. According to another embodiment, the operating system comprises the WINDOWS® SERVER operating system from MICROSOFT Corporation of Redmond, Washington. According to further embodiments, the operating system can comprise the UNIX operating system or one of its variants. It should be appreciated that other operating systems can also be utilized. The storage 1118 can store other system or application programs and data utilized by the device 1100.

In many additional embodiments, the storage 1118 or other computer-readable storage media is encoded with computer-executable instructions which, when loaded into the device 1100, may transform it from a general-purpose computing system into a special-purpose computer capable of implementing the embodiments described herein. These computer-executable instructions may be stored as program 1122 (e.g., an application) and transform the device 1100 by specifying how the processor(s) 1104 can transition between states, as described above. In some embodiments, the device 1100 has access to computer-readable storage media storing computer-executable instructions which, when executed by the device 1100, perform the various processes described above with regard to FIGS. 1-10 . In certain embodiments, the device 1100 can also include computer-readable storage media having instructions stored thereupon for performing any of the other computer-implemented operations described herein.

In many further embodiments, the device 1100 may include an interoperability management logic 1124. The interoperability management logic 1124 can be configured to perform one or more of the various steps, processes, operations, or other methods that are described above. Often, the interoperability management logic 1124 can be a set of instructions stored within a non-volatile memory that, when executed by the processor(s) 1104 can carry out these steps, etc. In some embodiments, the interoperability management logic 1124 may be a client application that resides on a network-connected device, such as, but not limited to, a server, switch, personal or mobile computing device in a single or distributed arrangement.

With the advent of IPv6, many brownfield deployments relying on IPv4 are migrating to IPv6 to leverage the advantages offered by IPv6. During the migration, conventional techniques often implement dual-stack configurations (e.g., supporting both IPv4 and IPv6 simultaneously). However, the usage of the dual-stack configurations may introduce certain complexities in network operations. For example, during the migration, a first VTEP operating on IPv4 transport may advertise an IPv4 origin address to a second VTEP, which is then recorded in a flood list of the second VTEP. Subsequently, as the first VTEP transitions to IPv6, the first VTEP may advertise both IPv6 and IPv4 origin addresses. This behavior can result in the second VTEP recording duplicate entries for the same VTEP in the flood list of the second VTEP. The presence of multiple origin addresses for a single VTEP in the flood list can inadvertently lead to packet duplication. To this end, in a number of embodiments, the interoperability management logic 1124 may be provided to avoid packet duplication.

In numerous embodiments, the interoperability management logic 1124 may be configured to support both the IPv4 and the IPv6 protocols. Upon supporting both the IPv4 and the IPv6 protocols, the interoperability management logic 1124 may be configured to generate a plurality of route advertisements having the same originating router address for the device 1100 during a BGP session. In an example, each route advertisement of the plurality of route advertisements may further include a primary next-hop address and a secondary next-hop address, each of which is independent of an IP version type of the originating router address. Further, the interoperability management logic 1124 may be configured to transmit the plurality of route advertisements. The transmission of the plurality of route advertisements having the same originating router address during the BGP session may enable a receiving device to determine that a route key associated with the device 1100 remains the same during the BGP session. Consequently, the receiving device may not record duplicate entries for the device 1100 in its flood list, thereby avoiding packet duplication.

In numerous additional embodiments, the underlay network data 1128 may include at least one of a first single-stack configuration, a second single-stack configuration, or a multi-stack configuration. In an example, the first single-stack configuration may correspond to a first set of configurational parameters that enables the device 1100 to perform a first IP version type VXLAN encapsulation scheme (and/or a first IP version type VXLAN decapsulation scheme) by defining first IP version type addresses, VXLAN Network Identifiers (VNIs), and User Datagram Protocol (UDP) port numbers necessary for establishing VXLAN tunnels. The second single-stack configuration may correspond to a second set of configurational parameters that enables the device 1100 to perform a second IP version type VXLAN encapsulation scheme (and/or a second IP version type VXLAN decapsulation scheme) by defining second IP version type addresses, the VNIs, and the UDP port numbers necessary for establishing VXLAN tunnels. The multi-stack configuration may include functionalities of both the first single-stack configuration and the second single-stack configuration.

In a variety of embodiments, the next-hop address data 1130 may include at least one of a primary next-hop address or a secondary next-hop address associated with the device 1100. In various examples, the primary next-hop address may conform to one of a first IP version type or a second IP version type. For example, the primary next-hop address may correspond to one of an IPv4 address or an IPv6 address associated with the device 1100. In numerous examples, the secondary next-hop address may conform to the remaining one of the first IP version type or the second IP version type. For example, the secondary next-hop address may correspond to the remaining one of the IPv4 or IPv6 addresses associated with the device 1100.

In various further embodiments, the originating router address data 1132 may include the originating router address associated with the device 1100. In various examples, the originating router address may remain the same throughout the BGP session established by the device 1100. In numerous examples, the originating router address may conform to one of the first IP version type or the second IP version type. In more examples, the originating router address may correspond to an existing IPv4 address associated with the device 1100. In some more examples, the originating router address may correspond to an existing IPv6 address associated with the device 1100.

In still further embodiments, the device 1100 can also include one or more input/output controllers 1116 for receiving and processing input from a number of input devices, such as a keyboard, a mouse, a touchpad, a touch screen, an electronic stylus, or other type of input device. Similarly, an input/output controller 1116 can be configured to provide output to a display, such as a computer monitor, a flat panel display, a digital projector, a printer, or other type of output device. Those skilled in the art will recognize that the device 1100 might not include all of the components shown in FIG. 11 and can include other components that are not explicitly shown in FIG. 11 or might utilize an architecture completely different than that shown in FIG. 11.

Finally, in numerous additional embodiments, data may be processed into a format usable by a machine-learning model 1126 (e.g., feature vectors), and or other pre-processing techniques. The machine-learning (“ML”) model 1126 may be any type of ML model, such as supervised models, reinforcement models, or unsupervised models. The ML model 1126 may include one or more of linear regression models, logistic regression models, decision trees, Naïve Bayes models, neural networks, k-means cluster models, random forest models, or other types of ML models 1126.

The ML model(s) 1126 can be configured to generate inferences to make predictions or draw conclusions from data. An inference can be considered the output of a process of applying a model to new data. This can occur by learning from at least the underlay network data 1128, the next-hop address data 1130, and the originating router address data 1132 and using that learning to predict future outcomes. These predictions are based on patterns and relationships discovered within the data. To generate an inference, the trained model can take input data and produce a prediction or a decision. The input data can be in various forms, such as images, audio, text, or numerical data, depending on the type of problem the model was trained to solve. The output of the model can also vary depending on the problem, and can be a single number, a probability distribution, a set of labels, a decision about an action to take, etc. Ground truth for the ML model(s) 1126 may be generated by human/administrator verifications or may compare predicted outcomes with actual outcomes. Further, the ML model(s) 1126 may be utilized to generate the plurality of route advertisements by learning the underlay network data 1128, the next-hop address data 1130, and/or the originating router address data 1132.

Although a specific embodiment for a device 1100 suitable for configuration with the interoperability management logic for carrying out the various steps, processes, methods, and operations described herein is discussed with respect to FIG. 11, any of a variety of systems and/or processes may be utilized in accordance with embodiments of the disclosure. For example, the device 1100 may correspond to a mobile computing device such as a laptop (or a smartphone), or may correspond to a network device such as an AP. The elements depicted in FIG. 11 may also be interchangeable with other elements of FIGS. 1-10 as required to realize a particularly desired embodiment.

Although the present disclosure has been described in certain specific aspects, many additional modifications and variations would be apparent to those skilled in the art. In particular, any of the various processes described above can be performed in alternative sequences and/or in parallel (on the same or on different computing devices) in order to achieve similar results in a manner that is more appropriate to the requirements of a specific application. It is therefore to be understood that the present disclosure can be practiced other than specifically described without departing from the scope and spirit of the present disclosure. Thus, embodiments of the present disclosure should be considered in all respects as illustrative and not restrictive. It will be evident to the person skilled in the art to freely combine several or all of the embodiments discussed here as deemed suitable for a specific application of the disclosure. Throughout this disclosure, terms like “advantageous”, “exemplary” or “example” indicate elements or dimensions which are particularly suitable (but not essential) to the disclosure or an embodiment thereof and may be modified wherever deemed suitable by the skilled person, except where expressly required. Accordingly, the scope of the disclosure should be determined not by the embodiments illustrated, but by the appended claims and their equivalents.

Any reference to an element being made in the singular is not intended to mean “one and only one” unless explicitly so stated, but rather “one or more.” All structural and functional equivalents to the elements of the above-described preferred embodiment and additional embodiments as regarded by those of ordinary skill in the art are hereby expressly incorporated by reference and are intended to be encompassed by the present claims.

Moreover, no requirement exists for a system or method to address each and every problem sought to be resolved by the present disclosure, for solutions to such problems to be encompassed by the present claims. Furthermore, no element, component, or method step in the present disclosure is intended to be dedicated to the public regardless of whether the element, component, or method step is explicitly recited in the claims. Various changes and modifications in form, material, workpiece, and fabrication material detail can be made, without departing from the spirit and scope of the present disclosure, as set forth in the appended claims, as might be apparent to those of ordinary skill in the art, are also encompassed by the present disclosure.

What is claimed is:

1. A multi-stack capable device, comprising:
a processor; and
a memory communicatively coupled to the processor, wherein the memory comprises an interoperability management logic that is configured to:
support a first Internet Protocol (IP) version type and a second IP version type;
generate a plurality of route advertisements having same originating router address during a border gateway protocol (BGP) session,
wherein each route advertisement of the plurality of route advertisements includes a primary next-hop address and a secondary next-hop address of the multi-stack capable device, and
wherein the primary next-hop address conforms to one of the first IP version type or the second IP version type independent of the originating router address, and the secondary next-hop address conforms to remaining of the first IP version type or the second IP version type; and
transmit the plurality of route advertisements.

2. The multi-stack capable device of claim 1, wherein the originating router address conforms to one of the first IP version type or the second IP version type.

3. The multi-stack capable device of claim 1, wherein the originating router address is independent of an IP version type associated with the primary next-hop address.

4. The multi-stack capable device of claim 1, wherein based on the plurality of route advertisements having the same originating router address during the BGP session, a route key associated with the multi-stack capable device remains same during the BGP session.

5. The multi-stack capable device of claim 1, wherein the primary next-hop address is included in a first attribute of a corresponding route advertisement of the plurality of route advertisements, and the secondary next-hop address is included in a second attribute of the corresponding route advertisement.

6. The multi-stack capable device of claim 5, wherein the first attribute corresponds to a Network Layer Reachability Information (NLRI) attribute.

7. The multi-stack capable device of claim 6, wherein the first attribute corresponds to a Multiprotocol Reachability NLRI (MP_REACH_NLRI) attribute.

8. The multi-stack capable device of claim 5, wherein the second attribute corresponds to a BGP tunnel encapsulation attribute.

9. The multi-stack capable device of claim 8, wherein the second attribute corresponds to a Tunnel Egress Endpoint field within the BGP tunnel encapsulation attribute.

10. The multi-stack capable device of claim 1, wherein the first IP version type corresponds to one of an IP version 4 (IPv4) or an IP version 6 (IPv6), and the second IP version type corresponds to remaining of the IPv4 or IPv6.

11. The multi-stack capable device of claim 1, wherein the plurality of route advertisements comprises at least one BGP route update advertisement.

12. The multi-stack capable device of claim 1, wherein the interoperability management logic is further configured to support a plurality of underlay network configurations including a first underlay network configuration associated with the first IP version type and a second underlay network configuration associated with the second IP version type.

13. The multi-stack capable device of claim 12, wherein the primary next-hop address is associated with one of the first underlay network configuration or the second underlay network configuration that is prioritized for routing, and the secondary next-hop address is associated with remaining of the first underlay network configuration or the second underlay network configuration.

14. The multi-stack capable device of claim 13, wherein the primary next-hop address conforms to the first IP version type and the secondary next-hop address conforms to the second IP version type in a case where the first underlay network configuration is prioritized over the second underlay network configuration for routing.

15. The multi-stack capable device of claim 13, wherein the primary next-hop address conforms to the second IP version type and the secondary next-hop address conforms to the first IP version type in a case where the second underlay network configuration is prioritized over the first underlay network configuration for routing.

16. A device, comprising:
a processor; and
a memory communicatively coupled to the processor, wherein the memory comprises an interoperability management logic that is configured to:
switch from a first single-stack configuration supporting a first Internet Protocol (IP) version type to a multi-stack configuration supporting the first IP version type and a second IP version type;
generate, based on the switching to the multi-stack configuration, a first plurality of route advertisements having a same originating router address during a border gateway protocol (BGP) session,
wherein each route advertisement of the first plurality of route advertisements includes a primary next-hop address of the device, and
wherein the primary next-hop address conforms to one of the first IP version type or the second IP version type independent of the originating router address; and
transmit the first plurality of route advertisements.

17. The device of claim 16, wherein each route advertisement of the first plurality of route advertisements further includes a secondary next-hop address of the device, and wherein the secondary next-hop address conforms to remaining of the first IP version type or the second IP version type.

18. The device of claim 16, wherein the interoperability management logic is further configured to switch from the multi-stack configuration supporting the first IP version type and the second IP version type to a second single-stack configuration supporting the second IP version type.

19. The device of claim 18, wherein prior to switching to the multi-stack configuration, the interoperability management logic is further configured to transmit at least one route advertisement having the same originating router as the first plurality of route advertisements, wherein based on the switching to the second single-stack configuration, the interoperability management logic is further configured to transmit a second plurality of route advertisements having the same originating router address as the first plurality of route advertisements, and wherein each route advertisement of the second plurality of route advertisements includes a single next-hop address conforming to the second IP version type.

20. A method, comprising:
supporting a first Internet Protocol (IP) version type and a second IP version type;
generating a plurality of route advertisements having same originating router address during a border gateway protocol (BGP) session,
wherein each route advertisement of the plurality of route advertisements includes a primary next-hop address and a secondary next-hop address of a multi-stack capable device, and
wherein the primary next-hop address conforms to one of the first IP version type or the second IP version type independent of the originating router address, and the secondary next-hop address conforms to remaining of the first IP version type or the second IP version type; and
transmitting the plurality of route advertisements.
